(19) United States
(12) Patent Application Publication
(10) Pub. No.: US 2026/0323406 A1
(43) Pub. Date: Oct. 15, 2026

(54) MANAGING PROTOCOL DATA UNIT SETS IN HANDOVER SCENARIOS

(71) Applicant: GOOGLE LLC, Mountain View, CA (US)

(72) Inventor: Chih-Hsiang Wu, Taoyuan City (TW)

(21) Appl. No.: 19/486,029

(22) PCT Filed: May 19, 2024
(86) PCT No.: PCT/US2024/030130

§ 371 Date: Nov. 19, 2025

Related U.S. Application Data
(60) Provisional application No. 63/503,448, filed on May 19, 2023.

(51) Int. Cl. H04W 36/00; H04W 24/02

(52) U.S. Cl. CPC H04W 36/0044; H04W 24/02

(57) ABSTRACT

A network node transmits, to a target base station, a handover request for a UE. The handover request includes packet data unit (PDU) set quality of service (QOS) parameters for a QoS flow. The network node receives, from the target base station and in response to the handover request, configuration parameters for the UE. The network node transmits, to the UE, the configuration parameters.

### CROSS-REFERENCE TO RELATED APPLICATION

This application claims priority to and the benefit of the filing date of provisional U.S. Patent Application No. 63/503,448 entitled “Managing Protocol Data Unit Sets in Handover Scenarios,” filed on May 19, 2023. The entire content of the provisional application is hereby expressly incorporated herein by reference.

### FIELD OF THE DISCLOSURE

This disclosure relates to wireless communications and, more particularly, to managing protocol data unit (PDU) Set based data communications in handover scenarios.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer. A core network communicates data with the UE via the RAN using multiple layers of a protocol stack.

Some of the services fifth-generation systems (5GS) require a high data rate and low-latency transmissions. One example of such services is extended Reality (XR), which includes Augmented Reality (AR), Virtual Reality (VR), and Mixed Reality (MR). In virtual reality applications, the user is fully immersed in a virtual environment that fully replaces the real, physical environment, typically by wearing a head-mounted device. In augmented reality, an application augments the perception of the real environment by overlaying virtual elements on the perception of the real environment. Augmented reality recently became the foundation of a widely popular game in which players seek out and interact with virtual creatures superimposed onto a real-time video stream of the real world. Finally, mixed reality is an extension of AR, where real and virtual elements can interact in real time.

XR games and other applications often run on cloud platforms that include remote servers, and generally do not require games consoles, high-spec CPUs, or high-spec GPUs. Cloud gaming involves streaming a game similar to streaming a video, and the game responds to the gamer's commands and controls in real time.

To better support high-data-rate, low-latency services such as XR, the 3rd Generation Partnership Project (3GPP) recently proposed to group certain Packet Data Units (PDUs) into sets of multiple PDUs carrying the payload of one unit of information generated at the application level (e.g., frames or video slices) and having the same importance for the application level, and support PDU set-based quality of service (QoS) requirements. However, it is not clear how a core network (CN), radio access network (RAN) nodes, or a UEs should support PDU set-based QoS requirements in handover scenarios.

### SUMMARY

An example embodiment of the techniques of this disclosure is a method implemented in a network node. The method comprises transmitting, to a target base station, a handover request for a UE, the handover request including packet data unit (PDU) Set quality of service (QoS) parameters for a QoS flow; receiving, from the target base station and in response to the handover request, configuration parameters for the UE; and transmitting, to the UE, the configuration parameters.

Another example embodiment of these techniques is a method implemented in a radio access network (RAN) node. The method comprises receiving, from a network node, a handover request for a UE, the handover request including packet data unit (PDU) Set quality of service (QoS) parameters for a QoS flow; transmitting, to the network node and in response to the handover request, configuration parameters for the UE; and communicating with the UE using the PDU Set QoS parameters.

Yet another example embodiment of these techniques is an apparatus comprising processing hardware and configured to implement one of the methods above.

### BRIEF DESCRIPTION OF THE DRAWINGS

FIG. 1A is a block diagram of an example system in which one or more base stations and/or a user equipment (UE) can implement the techniques of this disclosure for managing PDU set based data communication during a handover between the UE and a radio access network (RAN);

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example scenario in which a CN transmits PDU set QoS parameters to a CU-CP, which transmits the PDU set related information to a CU-UP to perform PDU set handing for data communication between the CU-UP and a DU;

FIG. 4 is a messaging diagram of an example scenario in which a CU transmits PDU set QoS parameters to a target DU during a handover preparation, and the target DU configures resources based on the PDU set QoS parameters during the handover preparation procedure;

FIG. 5A is a messaging diagram of an example scenario in which a source base station transmits PDU set QoS parameters to a target base station during a handover preparation procedure, and the target base station configures resources based on the PDU set QoS parameters during the handover preparation procedure;

FIG. 5B a messaging diagram of an example scenario in which a source base station indicates that a handover is required to a CN, and the CN transmits PDU set QoS parameters to the target base station;

FIG. 6A is a flow diagram of an example method for managing PDU set communications in a handover scenario, which can be implemented in a source RAN node;

FIG. 6B is a flow diagram of an example method generally similar to that of FIG. 6A, but in which the source RAN node additionally checks whether PDU set QoS parameters were previously received;

FIG. 7A is a flow diagram of an example method for managing PDU set communications in a handover scenario, which can be implemented in a CN;

FIG. 7B is a flow diagram of an example method generally similar to that of FIG. 7A, but in which the CN additionally checks whether the PDU set QoS parameters are configured for the UE;

FIG. 7C is a flow diagram of an example method generally similar to that of FIG. 7A, but in which the CN provides PDU set QoS parameters to the target RAN node only if the handover message from the source RAN node included these or related PDU set QoS parameters;

FIG. 8A is a flow diagram of an example method for managing PDU set communications in a handover scenario, which can be implemented in a target RAN node;

FIG. 8B is a flow diagram of an example method generally similar to that of FIG. 8A, but in which the target RAN node uses PDU set QoS parameters only if the source RAN node provided these or related PDU set QoS parameters in a handover request message;

FIG. 9A is a flow diagram of an example method for managing PDU set communications in a handover scenario, which can be implemented in a central unit (CU) of a distributed base station;

FIG. 9B is a flow diagram of an example method generally similar to that of FIG. 9A, but in which the target RAN node provides PDU set QoS parameters to a DU only if the source RAN node provided these or related PDU set QoS parameters in a handover request message;

FIG. 10 is a flow diagram of an example method for managing PDU set communications in a handover scenario and providing PDU set QoS parameters to a target RAN node during a path switch procedure, which can be implemented in a CN;

FIG. 11 is a flow diagram of an example method for managing PDU set communications in a handover scenario and receiving PDU set QoS parameters to a target RAN node during a path switch procedure, which can be implemented in a target RAN node;

FIG. 12 is a flow diagram of an example method for configuring a UE for communication using PDU sets, which can be implemented in a RAN or CN node of FIG. 1A; and

FIG. 13 is a flow diagram of an example method for configuring a UE for communication using PDU sets, which can be implemented in a RAN node of FIG. 1A.

### DETAILED DESCRIPTION OF THE DRAWINGS

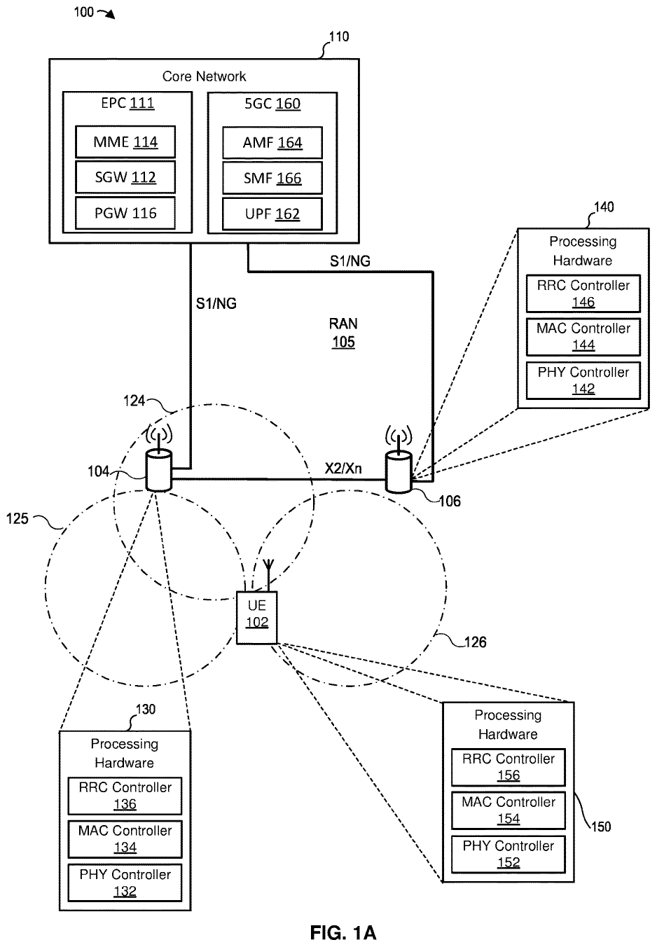

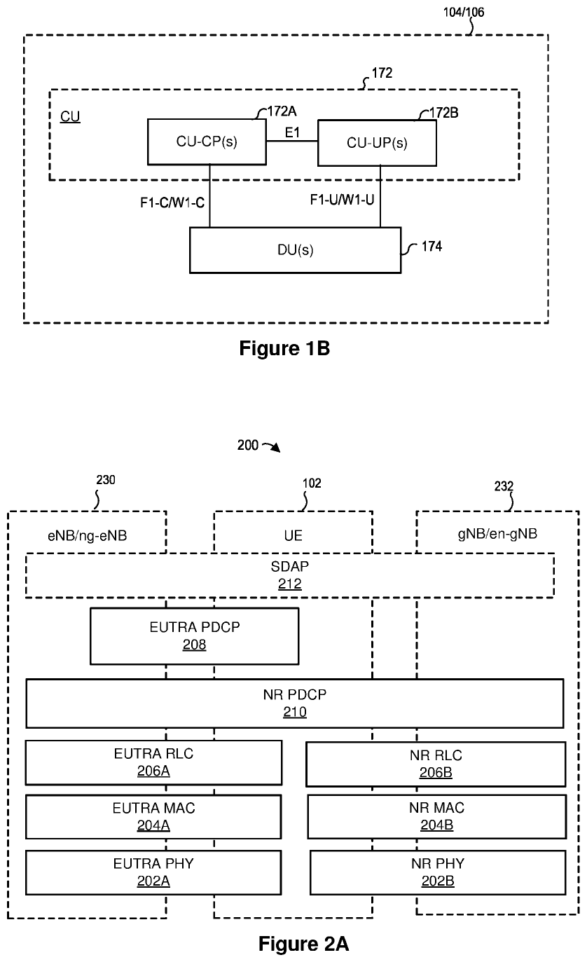

FIG. 1A depicts an example wireless communication system 100 in which communication devices can implement these techniques. The wireless communication system 100 includes a UE 102, a base station 104 (source BS 104), a base station 106 (operating in the handover scenarios discussed below as the target BS 106, and a core network (CN) 110. The UE 102 initially connects to the base station 104. The base stations 104 and 106 can operate in a RAN 105 connected to the CN 110. The CN 110 can be implemented as an evolved packet core (EPC) 111 or a fifth generation (5G) core (5GC), 160, for example.

Among other components, the EPC 111 can include a Serving Gateway (SGW) 112, a Mobility Management Entity (MME) 114, and a Packet Data Network Gateway (PGW) 116.

Generally speaking, the SGW 112 is configured to transfer user-plane packets related to audio calls, video calls, Internet traffic, etc., and the MME 114 is configured to manage authentication, registration, paging, and other related functions. The PGW 116 provides connectivity from the UE to external packet data networks including Internet network and/or an Internet Protocol (IP) Multimedia Subsystem (IMS) network by being the point of exit and entry of traffic for the UE. The 5GC 160 includes a User Plane Function (UPF) 162, an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The baes statin 104 can additionally supports a cell 125. The cells 124 and 125 can partially overlap, so that while communicating with the UE 102 via the cell 124, the base station 104 hands over the UE 102 to the cell 125. The cells 124 and 126 can partially overlap, so that while communicating with the UE 102 via the cell 124, the base station 104 hands over the UE 102 to the base station 106 operating as a target base station. To directly exchange messages during handover scenarios discussed below, the base station 104 and the base station 106 can support an X2 or Xn interface. In general, the CN 110 can connect to any suitable number of base stations supporting NR cells and/or EUTRA cells.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include a RLC controller (not show in FIG. 1A) configured to perform RLC functions with one or more user devices. The processing hardware 130 can further include a PDCP controller (not show in FIG. 1A) configured to perform PDCP functions with one or more user devices. The processing hardware 130 can further include an RRC controller 136 to implement procedures and messaging at the RRC sublayer of the protocol communication stack. For example, the RRC controller 132 may be configured to support RRC messaging associated with resource configuration, measurement configuration procedure and reconfiguration procedure and/or handover procedures. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing for communication with the base station 104 or 106, and communicating UL/DL MAC PDUs with the base station 104 or 106. The processing hardware 150 can further include an RRC controller 156 to implement procedures and messaging at the RRC sublayer of the protocol communication stack. The processing hardware 150 can further include a RLC controller (not show in FIG. 1A) configured to perform RLC functions with the base station 104 or 106. The processing hardware 150 can further include a PDCP controller (not show in FIG. 1A) configured to perform PDCP functions with the base station 104 or 106.

FIG. 1B depicts an example, distributed or disaggregated implementation of any one or more of the base stations 104, 106. In this implementation, the base station 104, 106 includes a central unit (CU) 172 and one or more DUs 174. Each of the DU(s) can operate one or more cells. For example, the base station 104 includes a DU operating the cell 124 and/or cell 125. In another example, the base station 104 includes a DU 174A and a DU 174B that operate the cell 124 and the cell 125, respectively. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include an RRC controller such as RRC controller 136, 146. The CU 172 can a PDCP controller and/or a Service Data Adaptation Protocol (SDAP) controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

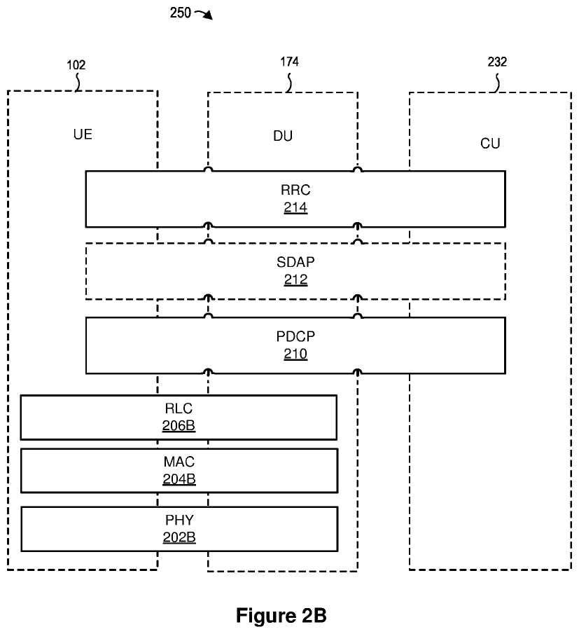

FIG. 2A illustrates, in a simplified manner, an example protocol stack 200 according to which the UE 102 can communicate with an eNB/ng-eNB 230 or a gNB 232 (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

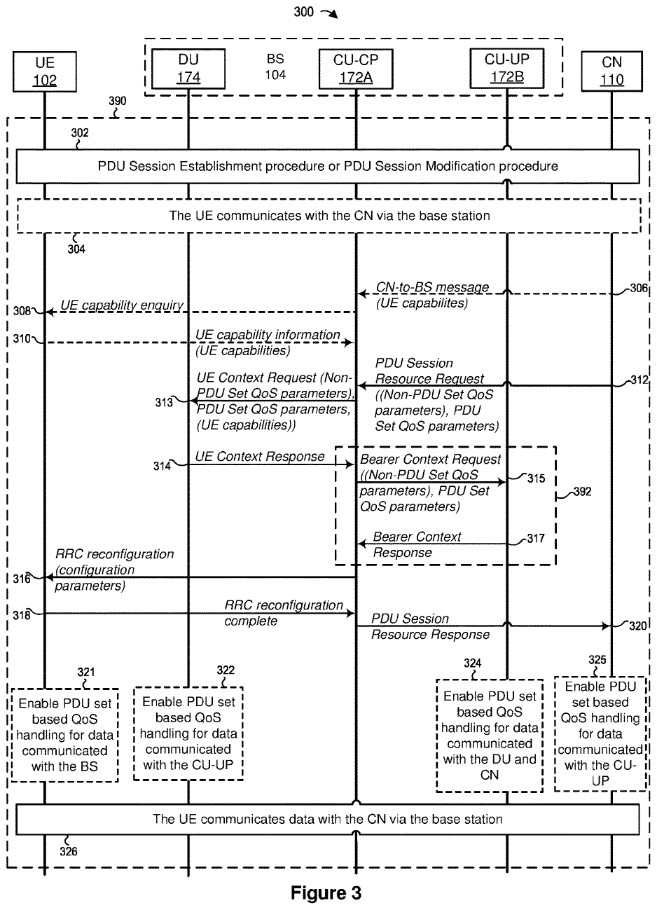

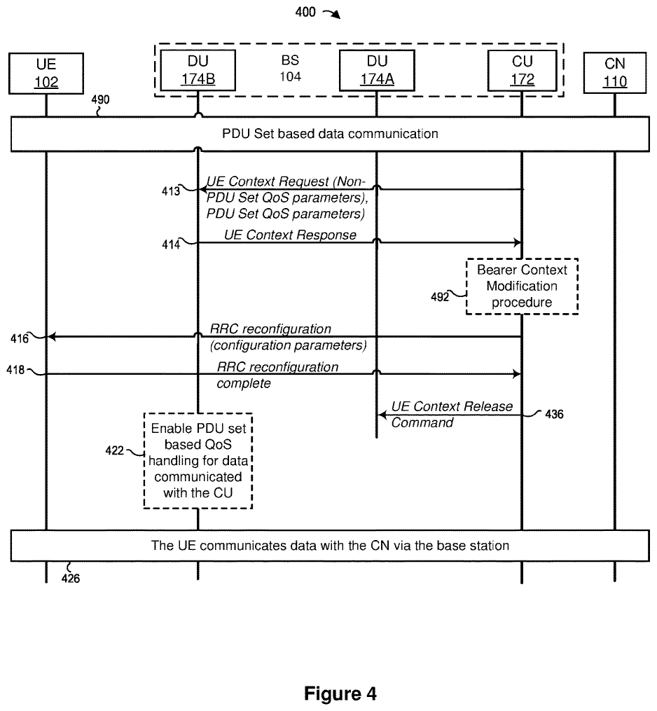

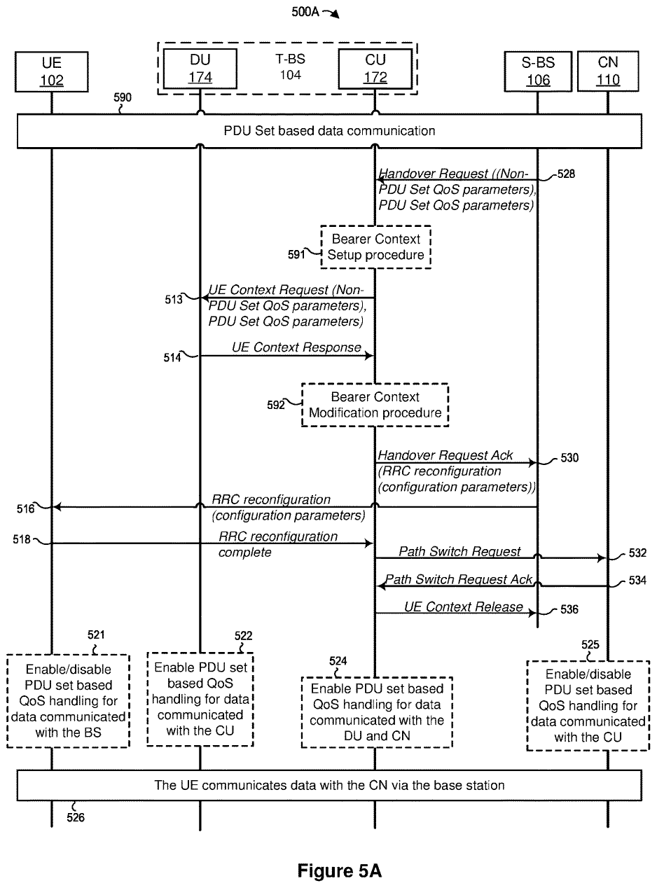

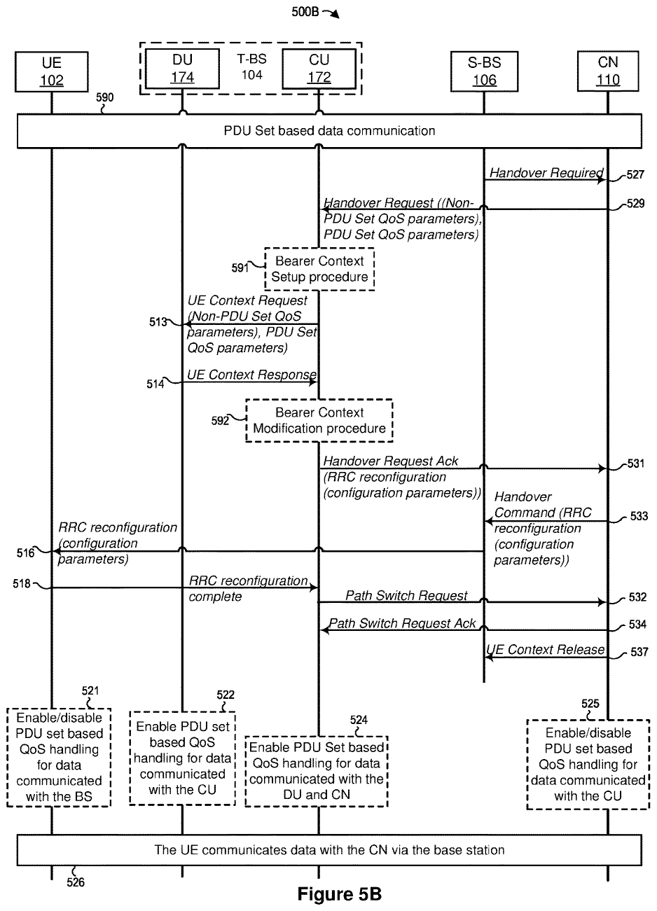

Next, several example scenarios in which the base station operating in the system of FIG. 1A and FIG. 1B communicates data with the UE 102. Generally speaking, events in FIGS. 3-5B that are similar are labeled with similar reference numbers (e.g., event 313 is similar to event 413 of FIG. 4, and event 513 of FIGS. 5A and 5B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the base station 104 includes a CU-CP 172A, a CU-UP 172B and a DU 174. Initially, the UE 102 performs 302 a PDU Session Establishment procedure or a PDU Session Modification procedure with the CN 110 via the base station 104 (e.g., CU-CP 172A and DU 174) or the base station 106 (not show in FIG. 3) to establish or modify a PDU session for performing one or more services. In some implementations, the service(s) such as XR services and/or cloud games require high-data-rate and low-latency transmissions. In some implementations, the UE 102 performs 302 the PDU Session Establishment procedure or the PDU Session Modification procedure with the SMF 166 via the AMF 164 and the base station 104 or 106.

During the PDU Session Establishment procedure, the UE 102 transmits a PDU Session Establishment Request message to the CN 110 via the base station (e.g., the baes station 104 or 106). In response, the CN 110 can send a PDU Session Establishment Accept message to the CN 110 via the base station. In response to the PDU Session Establishment Accept message, the UE 102 transmits a PDU Session Establishment Complete message to the CN 110 via the base station. During the PDU Session Modification procedure, the UE 102 transmits a PDU Session Modification Request message to the CN 110 via the base station. In response, the CN 110 can send a PDU Session Modification Command message to the CN 110 via the base station. In response to the PDU Session Modification Command message, the UE 102 then transmits a PDU Session Modification Complete message to the CN 110 via the base station.

In some implementations, the UE 102 can include, in the PDU Session Establishment Request message or PDU Session Modification Request message, a PDU session ID identifying the PDU session, the slice information, and/or the particular data network name (DNN). In some implementations, the CN 110 includes the PDU session ID in the PDU Session Establishment Accept message or the PDU Session Modification Command message to indicate that the PDU session is established or modified successfully. In some implementations, the slice information indicates a specific slice configured for the service(s). For example, the slice information can be a Single Network Slice Selection Assistance Information (S-NSSAI) or can include a portion of the S-NSSAI. In other implementations, the UE 102 can include, in the PDU Session Establishment Request message or PDU Session Modification Request message, UE-requested quality of service (QoS) parameters that the UE 102 requires to perform the service(s).

After performing 302 the PDU Session Establishment procedure or the PDU Session Modification procedure, the UE 102 communicates 304 with the CN 110 via the base station 104 (e.g., the CU-CP 172A, CU-UP 172B and DU 174). While communicating with the UE 102, the CU-CP 172A can receive 306 a CN-to-BS message including UE capabilities of the UE 102 from the CN 110. The CU-CP 172A can transmit a CU-to-DU message including the UE capabilities to the DU 174. The CU-to-DU message may be a F1 Application Protocol (F1AP) message, a UE Context Setup Request message or a UE Context Modification Request message. Alternatively, the CU-CP 172A transmits 308 a UE capability enquiry message to the UE 102 via the DU 174, to request the UE capabilities. In response, the UE 102 transmits 310 a UE capability information message including the UE capabilities to the CU-CP 172A via the DU 174.

In some implementations, the UE capabilities include dedicated capabilities indicating support of one or more functions/features for enhancing communication of data requiring high data rate and low latency, such as XR data or cloud gaming data (i.e., indicators defined specifically for the purpose of indicating capabilities with respect to high-data-rate, low-latency communications). For example, the function(s)/feature(s) include multiple configured grant (CG) Physical Uplink Shared Channel (PUSCH) transmission occasions in a period of a single CG PUSCH configuration, a dynamic indication of unused CG PUSCH occasion(s) based on UCI by the UE, buffer status reporting (BSR) enhancements including at least an additional or dedicated buffer status table(s), delay reporting of buffered data in uplink, provision of XR traffic assistance information for DL and UL (e.g. periodicity) and/or PDU set based QoS handling (e.g., discard operation of PDU set(s)). A PDU set includes one or more PDUs carrying a payload of one unit of information generated at the application level (e.g. frame(s) or video slice(s) etc. for a XR services).

During or after the procedure 302, or during the communication 304, the CN 110 transmits 312 a PDU Session Resource Request message to the CU-CP 172A to request the CU-CP 172A to assign resources for the PDU session and one or more QoS flows for the UE 102. The QoS flow(s) is/are associated with the PDU session. In some implementations, the CN 110 can include a first set of PDU set QoS parameters for the PDU session or the QoS flow(s) in the PDU Session Resource Request message. In one implementation, the CN 110 includes a first set of PDU set QoS parameters to request or configure PDU set based QoS handling for the PDU session or the QoS flow(s). After (e.g., in response to) receiving 312 the PDU Session Resource Request message, the CU-CP 172A transmits 313 a UE Context Request message for the PDU session or QoS flow(s) to the DU 174. In some implementations, the CU-CP 172A includes a second set of PDU set QoS parameters in the UE Context Request message to request or configure PDU set based QoS handling for the PDU session or the QoS flow(s). In some implementations, the second set of PDU set QoS parameters is identical to the first set of PDU set QoS parameters. In other implementations, at least some of the parameters in the second set of PDU set QoS parameters are different from the parameters in the first set of PDU set QoS parameters. In some implementations, the CU-CP 172A determines the second set of PDU set QoS parameters based on the first set of PDU set QoS parameters. In such cases, the CU-CP 172A ensures that the second set of PDU set QoS parameters satisfies the first set of PDU set QoS parameters. For example, the CU-CP 172A can determine the second set of PDU set QoS parameters more stringent than the first set of PDU set QoS parameters, considering latency in a F1-U connection between the CU-UP 172B and DU 174, data processing time at the CU-UP 172B, and/or data processing time at the DU 174.

In some implementations, the CU-CP 172A determines to include (or includes) the second set of PDU set QoS parameters in the UE Context Request message, if the CU-CP 172A, the CU-UP 172B and/or DU 174 support(s) PDU set based QoS handling. If the CU-CP 172A, CU-UP 172B and/or DU 174 do/does not support PDU set based QoS handling, the CU-CP 172A does not include PDU set QoS parameters (e.g., the second set of PDU set QoS parameters) in the UE Context Request message. In other implementations, the CU-CP 172A determines to include (or includes) the second set of PDU set QoS parameters in response to receiving at least one of the dedicated capabilities. If the UE capabilities do not include the dedicated capability/capabilities, the CU-CP 172A may not include the second set of PDU set QoS parameters in the UE Context Request message.

In some implementations, the CN 110 can provide corresponding PDU set QoS parameters for each of the QoS flow(s) indicated in the PDU Session Resource Request message. In such cases, the CU-CP 172A can include a (corresponding) set of PDU set QoS parameters in the UE Context Request message. In some implementations, for each of the QoS flow(s), the corresponding set of PDU set QoS parameters in the UE Context Request message is the same as or identical to the corresponding set of PDU set QoS parameters in the PDU Session Resource Request message. In other implementations, for each of the QoS flow(s), the CU-CP 172A determines the corresponding set of PDU set QoS parameters in the UE Context Request message based on the corresponding set of PDU set QoS parameters in the PDU Session Resource Request message.

In some implementations, the CN 110 can include 312, in the PDU Session Resource Request message, a first set of non-PDU set QoS parameters (i.e., QoS parameter(s) not related to a PDU set). In such cases, the CU-CP 172A can include a second set of non-PDU set QoS parameters in the UE Context Request message. In some implementations, the second set of non-PDU set QoS parameters is the same as or identical to the first set of non-PDU set QoS parameters. In other implementations, the CU-CP 172A determines the second set of non-PDU set QoS based on the first set of non-PDU set QoS parameters. In some implementations, the CN 110 includes a (corresponding) set of non-PDU set QoS parameter(s) for each of the QoS flow(s) in the PDU Session Resource Request message. In such cases, the CU-CP 172A can include a (corresponding) set of non-PDU set QoS parameters for each of the QoS flow(s) in the UE Context Request message. In some implementations, for each of the QoS flow(s), the corresponding set of non-PDU set QoS parameters in the UE Context Request message is the same as or identical to the corresponding set of non-PDU set QoS parameters in the PDU Session Resource Request message. In other implementations, for each of the QoS flow(s), the CU-CP 172A determines the corresponding set of non-PDU set QoS parameters in the UE Context Request message based on the corresponding set of non-PDU set QoS parameters in the PDU Session Resource Request message. In other implementations, the CN 110 does not include, in the PDU Session Resource Request message, non-PDU set QoS parameters for the PDU session or QoS flow(s). In such cases, the CU-CP 172A may not include, in the UE Context Request message, non-PDU set QoS parameters for the PDU session or QoS flow(s).

In some implementations, one or more non-PDU set QoS parameters (described above) include a QoS identifier descriptor, a maximum flow bit rate for DL, a maximum flow bit rate for UL, a guaranteed flow bit rate for DL, and/or a guaranteed flow bit rate for UL.

In some implementations, the CN 110 includes 312 a PDU Session ID identifying the PDU session in the PDU Session Resource Request message. In some implementations, the CN 110 includes 312 one or more QoS flow identifiers identifying the QoS flow(s) in the PDU Session Resource Request message. Each of the QoS flow identifier(s) identifies a particular QoS flow of the QoS flow(s). In some implementations, the CU-CP 172A includes the QoS flow identifier(s) in the UE Context Request message and associate (each of) the QoS flow identifier(s) with the (corresponding) set of the PDU set QoS parameters and/or non-PDU set QoS parameters.

In response to receiving 313 the UE Context Request message, the DU 174 transmits 314 a UE Context Response message to the CU-CP 172A. In some implementations, the DU 174 assigns resources for the PDU Session or QoS flow(s), generates DU configuration parameters for communicating data associated with the PDU session or QoS flow(s), and includes 314 the DU configuration parameters in the UE Context Response message. In some implementations, the DU 174 includes DL transport layer information in the UE Context Response message. In one implementation, the DL transport layer information configures a tunnel (e.g., General Packet Radio System (GPRS) Tunneling Protocol User Plane (GTP-U) tunnel) for the CU-UP 172B to transmit DL PDUs for the UE 102 to the DU 174 in the event 326.

In some implementations, if the DU 174 supports PDU set based QoS handling or the second set of PDU set QoS parameters, the DU 174 includes 314, in the UE Context Response message, confirmation information explicitly indicating that the DU 174 applies PDU set based QoS handling (e.g., for the PDU session or QoS flow(s)), based on the second set of PDU set QoS parameters. In other implementations, if the DU 174 does not support PDU set based QoS handling or the second set of PDU set QoS parameters, the DU 174 includes 314 non-support information (e.g., one or more cause values) in the UE Context Response message to indicate that the DU 174 does not support PDU set based QoS handling or the second set of PDU set QoS parameters. In some alternative implementations, the DU 174 implicitly indicates that the DU 174 supports PDU set based QoS handling or the second set of PDU set QoS parameters, by excluding the non-support information from the UE Context Response message.

In some implementations, if the DU 174 supports the second set of PDU set QoS parameters or PDU set based QoS handling, the DU 174 assigns resources for the PDU Session or QoS flow(s) and/or generates some or all of the configuration parameters, based on the second set of PDU set QoS parameters. In some implementations, if the UE 102 and/or DU 174 support(s) the second set of PDU set QoS parameters or PDU set based QoS handling, the DU 174 can enable 322 PDU set based QoS handling (e.g., for the PDU session or QoS flow(s)). In one implementation, the DU 174 enables 322 PDU set based QoS handling after (e.g., in response to) receiving the second set of PDU set QoS parameters or the UE Context Request message. In another implementation, the DU 174 enables 322 PDU set based QoS handling (e.g., for the PDU session or QoS flow(s)), regardless of whether or before receiving the second set of PDU set QoS parameters or the UE Context Request message.

In some implementations, if the UE 102 and/or DU 174 support(s) PDU set based QoS handling and/or the UE Context Request message includes PDU set QoS parameters (e.g., the second set of PDU set QoS parameters), the DU 174 can include 314, in the DU configuration parameters, at least one configuration parameter for PDU set based QoS handling. In some implementations, the DU 174 can additionally consider the second set of non-PDU set QoS parameters when generating the configuration parameters and/or assigning resources for the UE 102. In other implementations, the DU 174 ignores the second set of non-PDU set QoS parameters when generating the configuration parameters and/or assigning resources for the UE 102. By properly assigning resources for the UE 102 and/or configuring the configuration parameters, the DU 174 ensures that devices communicate 326 data associated with the PDU session or QoS flow(s) in compliance with the second set of PDU set QoS parameters and/or the second set of non-PDU set QoS parameters. In some implementations, if the UE 102 and/or DU 174 support(s) PDU set based QoS handling and/or the UE Context Request message includes PDU set QoS parameters (e.g., the second set of PDU set QoS parameters), the DU 174 generates the at least one configuration parameter. Otherwise, if the UE 102 and/or DU 174 do(es) not support PDU set based QoS handling and/or the UE Context Request message does not include PDU set QoS parameters, the DU 174 not include the at least one configuration parameter in the configuration parameters 314. In this case, the UE 102 does not enable or disables PDU set based QoS handling in response to receiving the configuration parameters that exclude the at least one configuration parameter.

In other implementations, if the UE 102 and/or DU 174 do(es) not support the second set of PDU set QoS parameters or PDU set based QoS handling, the DU 174 assigns resources for the PDU Session or QoS flow(s) and/or generates the configuration parameters, based on the second set of non-PDU set QoS parameters. If the UE 102 and/or DU 174 do(es) not support the second set of PDU set QoS parameters or PDU set based QoS handling and the UE Context Request message does not include non-PDU set QoS parameters, the DU 174 assigns resources for the PDU Session or QoS flow(s) and/or generates the configuration parameters based on predefined QoS parameters. In such implementations, the configuration parameters exclude the at least one configuration parameter for PDU set based QoS handling. By properly assigning resources and/or configuring the configuration parameters for the UE 102, the DU 174 ensures that devices communicate 326 data associated with the PDU session or QoS flow(s) in compliance with the second set of non-PDU set QoS parameters or predefined QoS parameters.

In some implementations, the CU-CP 172A includes 313 the UE capabilities in the UE Context Request message. In other implementations, the CU-CP 172A transmits another CU-to-DU message including the UE capabilities to the DU 174. In response, the DU transmits a DU-to-CU message to the CU-CP 172A. The CU-to-DU message and DU-to-CU message can be a UE Context Setup Request message and a UE Context Setup Response message, respectively. Thus, the DU 174 can determine whether the UE 102 supports PDU set based QoS handling based on the UE capabilities.

The UE Context Request message and UE Context Response message collectively define a UE Context procedure (e.g., a UE Context Setup procedure or a UE Context Modification procedure). In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively. In some alternative implementations, the DU 174 includes the configuration parameters in a UE Context Modification Required message instead of the UE Context Response message and transmits the UE Context Modification Required message to the CU-CP 172A. In this case, the CU-CP 172A can transmit a UE Context Modification Confirm message to the DU 174 in response to the UE Context Modification Required message.

After receiving 312 the PDU Session Resource Request message, transmitting 313 the UE Context Request message, or receiving 314 UE Context Response message, the CU-CP 172A performs 392 a Bearer Context procedure with the CU-UP 172B to establish or modify a bearer context for the UE 102. During the Bearer Context procedure, the CU-CP 172A transmits 315 a Bearer Context Request message for the UE 102 (e.g., for the PDU session or QoS flow(s)) to the CU-UP 172B and in response, the CU-UP 172B transmits 317 a Bearer Context Response message to the CU-CP 172A. In some implementations, the CU-UP 172B includes 317 UL transport layer information in the Bearer Context Response message. The UL transport layer information can include a configuration for a tunnel (e.g., GTP-U tunnel) via which the DU 174 can transmit 326 UL PDUs received from the UE 102 to the CU-UP 172B. The CU-CP 172A then includes 313 the UL transport layer information in the UE Context Request message. After receiving 314 UE Context Response message, the CU-CP 172A can perform 392 a Bearer Context Modification procedure with the CU-UP 172B to provide the DL transport layer information received in the UE Context Response message. In the Bearer Context Modification procedure, the CU-CP 172A transmits a Bearer Context Modification Request message including the DL transport layer information to the CU-UP 172B and in response, the CU-UP 172B transmits a Bearer Context Modification Response message.

In some implementations, the Bearer Context procedure is a Bearer Context Setup procedure, and the Bearer Context Request message and the Bearer Context Response message are a Bearer Context Set Request message and a Bearer Context Setup Response message, respectively. In other implementations, the Bearer Context procedure is a Bearer Context Modification procedure, and the Bearer Context Request message and the Bearer Context Response message are a Bearer Context Modification Request message and a Bearer Context Modification Response message, respectively. In such cases, the CU-CP 172A can include the DL transport layer information in the Bearer Context Modification Request message.

In some implementations, the CU-CP 172A can include a third set of PDU set QoS parameters for the UE 102 (e.g., for the PDU session or QoS flow(s)) in the Bearer Context Request message to request or configure PDU set based QoS handling for the PDU session or QoS flow(s). In some implementations, the third set of PDU set QoS parameters is the same as or identical to the first or second set of PDU set QoS parameters. In other implementations, the third set of PDU set QoS parameters is different from the first set of PDU set QoS parameters and/or the second set of PDU set QoS parameters. In some implementations, the CU-CP 172A determines the third set of PDU set QoS parameters based on the first set of PDU set QoS parameters. In such cases, the CU-CP 172A ensures that the third set of PDU set QoS parameters satisfies the first set of PDU set QoS parameters. For example, the CU-CP 172A can define the third set of PDU set QoS parameters as conforming to more stringent requirements than the first set of PDU set QoS parameters, considering latency in a F1-U connection between the CU-UP 172B and DU 174, data processing time at the CU-UP 172B, and/or data processing time at the DU 174. In some implementations, the third set of PDU set QoS parameters are the same as the second set of PDU set QoS parameters.

In some implementations, the CU-CP 172A determines to include (or includes) 315 the third set of PDU set QoS parameters in the Bearer Context Request message, if the CU-CP 172A and/or CU-UP 172B support(s) PDU set based QoS handling. If at least one of the CU-CP 172A or CU-UP 172B does not support PDU set based QoS handling, the CU-CP 172A may not include 315 PDU set QoS parameters (e.g., the third set of PDU set QoS parameters) in the Bearer Context Request message. In other implementations, the CU-CP 172A determines to include (or includes) the third set of PDU set QoS parameters in the Bearer Context Request message, in response to receiving at least one of the (new) capabilities. If the UE capabilities do not include the (new) capability/capabilities, the CU-CP 172A may not include the third set of PDU set QoS parameters in the Bearer Context Request message.

When the CN 110 provides one or more PDU set QoS parameters for each of the QoS flow(s) indicated 312 in the PDU Session Resource Request message, the CU-CP 172A can include a (corresponding) set of PDU set QoS parameters in the Bearer Context Request message. In some implementations, for each of the QoS flow(s), the corresponding set of PDU set QoS parameters in the Bearer Context Request message is the same as (or identical to) the corresponding set of PDU set QoS parameters in the PDU Session Resource Request message. In other implementations, for each of the QoS flow(s), the CU-CP 172A determines the corresponding set of PDU set QoS parameters in the Bearer Context Request message, based on the corresponding set of PDU set QoS parameters in the PDU Session Resource Request message, similar to determining the third set of PDU set QoS parameters as described above.

When the CN 110 provides 312, in the PDU Session Resource Request message, the first set of non-PDU set QoS parameters (i.e., QoS parameter(s) not related to a PDU set), the CU-CP 172A can include 315 a third set of non-PDU set QoS parameters in the Bearer Context Request message. In some implementations, the third set of non-PDU set QoS parameters is the same as or identical to the first set of non-PDU set QoS parameters. In other implementations, the CU 172 determines the third set of non-PDU set QoS based on the first set of non-PDU set QoS parameters. In some implementations, the CN 110 includes a (corresponding) set of non-PDU set QoS parameter(s) for each of the QoS flow(s) in the PDU Session Resource Request message. In such cases, the CU 172 can include a (corresponding) set of non-PDU set QoS parameters for each of the QoS flow(s) in the Bearer Context Request message. In some implementations, for each of the QoS flow(s), the corresponding set of non-PDU set QoS parameters in the Bearer Context Request message is the same as or identical to the corresponding set of non-PDU set QoS parameters in the PDU Session Resource Request message. In other implementations, for each of the QoS flow(s), the CU-CP 172A determines the corresponding set of non-PDU set QoS parameters in the Bearer Context Request message based on the corresponding set of non-PDU set QoS parameters in the PDU Session Resource Request message. In other implementations, the CN 110 does not include, in the PDU Session Resource Request message, non-PDU set QoS parameters for the PDU session or QoS flow(s). In such cases, the CU 172 can not include, in the Bearer Context Request message, non-PDU set QoS parameters for the PDU session or QoS flow(s).

In some implementations, the non-PDU set QoS parameters discussed above include(s) a QoS identifier descriptor, a maximum flow bit rate for DL, a maximum flow bit rate for UL, a guaranteed flow bit rate for DL, and/or a guaranteed flow bit rate for UL. In some implementations, the CU-CP 172A includes the QoS flow identifier(s) in the Bearer Context Request message and associate (each of) the QoS flow identifier(s) with the (corresponding) set of the PDU set QoS parameters and/or non-PDU set QoS parameters. In some implementations, the CU-CP 172A includes the PDU Session ID in the Bearer Context Request message.

In some implementations, the CU-UP 172B assigns resources for the PDU Session or QoS flow(s) in accordance with the Bearer Context Request message. In some implementations, the CU-UP 172B applies one or more configurations in the Bearer Context Request message to communicate data with the DU 174 and UE 102, where the data is associated with the PDU session or QoS flow(s). In some implementations, if the CU-UP 172B supports PDU set based QoS handling or the third set of PDU set QoS parameters, the CU-UP 172B includes, in the Bearer Context Response message, confirmation information explicitly indicating that the CU-UP 172B applies (e.g., performs) PDU set based QoS handling based on the third set of PDU set QoS parameters. In other implementations, if the CU-UP 172B does not support PDU set based QoS handling or the third set of PDU set QoS parameters, the CU-UP 172B includes non-support information (e.g., a cause (value)) in the Bearer Context Response message to indicate that the CU-UP 172B does not support PDU set based QoS handling or the third set of PDU set QoS parameters. In some alternative implementations, the CU-UP 172B implicitly indicates that the CU-UP 172B supports PDU set based QoS handling or the third set of PDU set QoS parameters, by excluding the non-support information in the Bearer Context Response message.

In some implementations, if the CU-UP 172B supports the third set of PDU set QoS parameters or PDU set based QoS handling, the CU-UP 172B assigns resources for the PDU session or QoS flow(s), based on the third set of PDU set QoS parameters. In some implementations, if the CU-UP 172B supports the third set of PDU set QoS parameters or PDU set based QoS handling, the CU-UP 172B can enable 324 PDU set based QoS handling. In some implementations, the CU-UP 172B enables 324 PDU set based QoS handling for the UE 102 (e.g., for the PDU session or QoS flow(s)), after (e.g., in response to) receiving the third set of PDU set QoS parameters or the Bearer Context Request message. In other implementations, the CU-UP 172B enables 324 PDU set based QoS handling, regardless of whether or before receiving the third set of PDU set QoS parameters or the Bearer Context Request message. In some implementations, the CU-UP 172B can additionally take the third set of non-PDU set QoS parameters into account when configuring the configuration parameters and/or assigning resources for the UE 102. In other implementations, the CU-UP 172B ignores the third set of non-PDU set QoS parameters. By properly assigning resources for the UE 102 and/or configuring the configuration parameters, the CU-UP 172B ensures that devices communicate 326 data associated with the PDU session or QoS flow(s) 326 between the DU 174 and/or the UE 102 in compliance with the (third/corresponding set of) PDU set QoS parameters and/or (third/corresponding set of) non-PDU set QoS parameters.

In other implementations, if the CU-UP 172B does not support the third set of PDU set QoS parameters or PDU set based QoS handling, the CU-UP 172B assigns resources for the PDU Session or QoS flow(s), based on the third set of non-PDU set QoS parameters. If the CU-UP 172B does not support the third set of PDU set QoS parameters or PDU set based QoS handling and the Bearer Context Request message does not include non-PDU set QoS parameters, the CU-UP 172B assigns resources for the PDU Session or QoS flow(s), based on predefined QoS parameters (e.g., non-PDU set QoS parameters). By properly assigning resources for the UE 102, the CU-UP 172B ensures that devices communicate 326 data associated with the PDU session or QoS flow(s) in compliance with the third set of non-PDU set QoS parameters, the predefined QoS parameters.

In some implementations, (each of) the (first, second and/or third) set(s) of PDU set QoS parameters include(s) PDU set Delay Budget (PSDB), PDU set Error Rate (PSER), and/or PDU set Integrated Handling Information (PSIHI). The PSDB may define an upper limit for a delay time that a PDU set may experience for the transfer between the UE 102 and the CN 110 (e.g., the UPF 162). For DL, the delay time may be the time duration between the reception time of the first PDU of a DL PDU set at the CN 110 (e.g., the UPF 162) and the time when all PDUs of the DL PDU set have been successfully received at the UE. For UL, the delay time may be the time duration between the reception time of the first PDU of a UL PDU set at the UE 102 (e.g., the reception time where a protocol layer of the UE 102 receives the first PDU from an application) and the time when all PDUs of the UL PDU set have been successfully received at the CN 110 (e.g., the UPF 162). The protocol layer can be the SDAP 212, PDCP 210, RLC 206 or MAC 204). In some implementations, the application can be an operating system (e.g., Android, IOS, Windows or Linux). In some implementations, the PSDB applies to a DL PDU set for the UE 102 received by the CN 110 (e.g., the UPF 162), and applies to the UL PDU set sent by the UE 102.

The PSER defines an upper bound for a rate of PDU sets that have been processed by a sender (e.g., the UE 102, CU 172 or DU 174) of a link layer protocol (e.g., RLC 206) but that are not successfully delivered by a corresponding receiver to an upper layer (e.g., PDCP 210) of the receiver. Thus, the PSER defines an upper bound for a rate of non-congestion related PDU set losses. The purpose of the PSER is to allow for appropriate link layer protocol configurations (e.g. PDCP configuration, RLC bearer configuration, MAC configuration and/or HARQ configuration) in the configuration parameters.

The PSIHI indicates whether the application layer in a receiver needs all PDUs (e.g., data packets) of a PDU set. If the PDU set is a DL PDU set, the receiver is the UE 102. If the PDU set is a UL PDU set, the receiver is the DU 174, CU-UP 172B or CN 110. In some implementations, the CU-UP 172B or DU 174 can determine whether to discard a PDU set associated with the PDU session or QoS flow(s), based on the PSIHI and the PSDB. For example, if the CU-UP 172B or DU 174 determines that transmission of a PDU set exceeds the PSDB, and the PSIHI indicates that the application layer in the UE 102 needs all PDUs of a PDU set, the CU-UP 172B or DU 174 can discard the PDU set. Otherwise, the CU-UP 172B or DU 174 does not discard the PDU set and transmits the PDU set to the DU 174 or UE 102.

After (e.g., in response to) receiving the UE Context Response message or UE Context Modification Required message, the CU-CP 172A transmits 316 an RRC reconfiguration message to the UE 102 via the DU 174. In response, the UE 102 transmits 318 an RRC reconfiguration complete message to the CU-CP 172A via the DU 174. If the CU-CP 172A receives the DU configuration parameters, the CU-CP 172A includes 316 the DU configuration parameters in the RRC reconfiguration message. In some implementations, if the UE 102 and/or base station 104 (e.g., the CU-CP 172A, CU-UP 172B and/or DU 174) support(s) PDU set based QoS handling and/or the PDU Session Resource Request message includes PDU set QoS parameters (e.g., the first set of PDU set QoS parameters), the CU-CP 172A can include at least one configuration for PDU set based QoS handling in the RRC reconfiguration message. The UE 102 enables 321 PDU set based QoS handling, in response to receiving the RRC reconfiguration message, configuration(s) for PDU set based QoS handling, and/or the configuration parameters(s) in the DU configuration parameters. Otherwise, if one or both of the UE 102 or base station 104 does not support PDU set based QoS handling, and/or if the PDU Session Resource Request message does not include PDU set QoS parameters, the CU-CP 172A does not include configuration parameter(s) for PDU set based QoS handling in the RRC reconfiguration message. Thus, the UE 102 refrains from enabling or disables PDU set based QoS handling in response to receiving the RRC reconfiguration message.

In some implementations, the CU-CP 172A includes 316 a measurement configuration and/or one or more DRB configurations in the RRC reconfiguration message. The UE 102 can measure a reference signal on a carrier frequency and report measurement results that the UE obtains from the measurement of the reference signal according to the measurement configuration. The DRB configuration(s) applies to one or more DRBs associated with the PDU session and/or QoS flow(s). Each of the DRB configuration(s) can include a PDCP configuration and/or a SDAP configuration. In some implementations, the CU-CP 172A includes the configuration parameter(s) for PDU set based QoS handling in the DRB configuration(s), PDCP configuration(s) and/or SDAP configuration(s). In some implementations, the DU configuration parameters include one or more RLC bearer configurations each configuring a RLC bearer for a particular DRB, and/or include MAC configuration parameters and/or physical layer configuration parameters. In some implementations, the CU-CP 172A generates the PDCP configuration(s) and/or SDAP configuration(s) based on the first set of PDU set QoS parameters, the second set of PDU set QoS parameters, or the third set of PDU set QoS parameters.

Before or after receiving 314 the UE Context Response message, or receiving 318 the RRC reconfiguration complete message, the CU-CP 172A transmits 320 a PDU Session Resource Response message to the CN 110 in response to receiving 312 the PDU Session Resource Request message. In some implementations, if the base station 104 supports PDU set based QoS handling as described above, the CU-CP 172A includes, in the PDU Session Resource Response message, confirmation information indicating that the base station 104 applies (e.g., performs) PDU set based QoS handling based on the first set of PDU set QoS parameters. In other implementations, if the base station 104 does not support PDU set based QoS handling (e.g., based on the first set of PDU set QoS parameters), the CU-CP 172A includes non-support information (e.g., a cause (value)) in the PDU Session Resource Response message to indicate that the base station 104 does not support PDU set based QoS handling or the first set of PDU set QoS parameters. In some alternative implementations, if the base station 104 supports PDU set based QoS handling as described above, the CU-CP 172A implicitly indicates that the base station 104 supports the first set of PDU set QoS parameters or PDU set based QoS handling, by excluding the non-supported information in the PDU Session Resource Response message.

In some implementations, the PDU Session Resource Request message and the PDU Session Resource Response message are a PDU Session Resource Setup Request message and a PDU Session Resource Setup Response message, respectively. In other implementations, the PDU Session Resource Request message and the PDU Session Resource Response message are a PDU Session Resource Modify Request message and a PDU Session Resource Modify Response message, respectively.

After receiving 320 the PDU Session Resource Response message, the CN 110 (e.g., the UPF 162) communicates 326 data packets associated with the PDU session or QoS flow(s) with the UE 102 via the base station 104. For example, the CN 110 transmits 326 DL data packets associated with the PDU session or QoS flow(s) to the CU-UP 172B. For each of the DL data packets, the CN 110 can generate a CN-to-CU-UP packet including one or more protocol headers and the DL data packet. For example, the CN-to-CU-UP packet is a GTP-U packet. The protocol header(s) include an Internet Protocol (IP) header, a User Datagram Protocol (UDP) header, and/or a GTP-U header. In some implementations, the CN 110 performs PDU set based QoS handling by grouping the DL data packets into (DL) PDU sets 1, . . . , N and transmits the PDU sets 1, . . . , N to the CU-UP 172B, where N is a positive integer and larger than one. For each of the DL data packets, the CN 110 generates DL PDU set information and transmits the PDU set information with the DL data packet to the CU-UP 172B.

In some implementations, the each PDU set information includes a PDU set Sequence Number, a PDU set size and/or a PDU set Importance indicator for a corresponding PDU set which the corresponding DL data packet belongs to. In some implementations, the each PDU set information includes an indication of an End PDU, so as to indicate whether the corresponding DL data packet in the PDU set is the last data packet in the PDU set, and/or a PDU Sequence Number for the corresponding DL data packet in the PDU set. In some implementations, the CN 110 includes the corresponding PDU set information in a header (e.g., GTP-U header) of each CN-to-CU-UP packet. For example, a DL PDU set K of the PDU sets 1, . . . , N includes M DL data packets K₁, . . . , K_{M}, where K and M are positive integers and 1≤K≤N and 1≤M. The CN 110 generates DL PDU set information K₁, K_{M} for the DL data packets K₁, . . . , K_{M}, respectively, and generates CN-to-CU-UP packets K₁, . . . , K_{M} including {PDU set information K₁, the DL data packet K₁}, {PDU set information K_{M}, the DL data packet K_{M}}, respectively. The CN 110 transmits the CN-to-CU-UP packets K₁, . . . , K_{M} to the CU-UP 172B. Each of the PDU set information K₁, . . . , K_{M} includes a PDU set Sequence Number. In some implementations, each of the PDU set information K₁, . . . , K_{M} includes a PDU set Size and/or a PDU set Importance indicator. The PDU set Sequence Number, PDU set Size and/or PDU set Importance indicator in the PDU set information K₁, . . . , K_{M} are the same or identical. In some implementations, the PDU set information K_{M} includes an indication of End PDU indicating the DL data packet K_{M} is the last packet in the PDU set K, and the PDU set information K₁, . . . , K_{M-1} includes an indication of End PDU indicating the corresponding DL data packet is not the last data packet in the PDU set K. In some implementations, the CN-to-CU-UP packets K₁, . . . , K_{M} are GTP-U packets and headers of the GTP-U packets K₁, . . . , K_{M} include the PDU set information K₁, . . . , K_{M}, respectively. In some implementations, the PDU set information K₁, . . . , K_{M} include PDU Sequence Numbers K₁, . . . , K_{M}, respectively. The PDU Sequence Numbers K₁, . . . , K_{M} indicate a sequence order of the data packets K₁, . . . , K_{M} in the PDU set K.

After receiving 326 the DL data packets from the CN 110, the CU-UP 172B transmits 326 the DL data packets to the DU 174. If the CU-UP 172B supports PDU set based QoS handling or the third set of PDU set QoS parameters or enables PDU set based QoS handling, the CU-UP 172B ensures that transmission of the DL data packets satisfies the third set of PDU set QoS parameters. If the CU-UP 172B receives the CN-to-CU-UP packets from the CN 110 as described above, the CU-UP 172B retrieves the DL data packets from the CN-to-CU-UP packets. For each of the DL data packets, the CU-UP 172B generates a DL PDU (e.g., DL PDCP PDU) including the DL data packet. The CU-UP 172B can generate a CU-UP-to-DU packet that includes one or more protocol headers and the DL data packet. For example, the CU-UP-to-DU packet is a GTP-U packet. The protocol header(s) include an IP header, a UDP header, and/or a GTP-U header. If the CU-UP 172B enables PDU set based QoS handling, the CU-UP 172B performs PDU set based QoS handling by grouping the DL PDUs into PDU sets 1, . . . , N and transmits the PDU sets 1, . . . , N to the DU 174. For each of the DL PDUs, the CU-UP 172B generates (corresponding) (DL) PDU set information and transmits the PDU set information with the DL PDU to the DU 174. The each PDU set information includes a PDU set Sequence Number, a PDU set size, a PDU set Importance indicator, an indication of End PDU indicating whether the data packet in a PDU set is the last data packet, and/or a PDU Sequence Number for the corresponding data packet within the PDU set. In some implementations, the CU-UP 172B includes the corresponding PDU set information in a header (e.g., GTP-U header) of the each CU-UP-to-DU packet.

For example, the CU-UP 172B receives CN-to-CU-UP packets K₁, . . . , K_{M} from the CN 110 and retrieves the data packets K₁, . . . , K_{M} from the CN-to-CU-UP packets K₁, . . . , K_{M}, respectively. The CU-UP 172B generates DL PDUs K₁, . . . , K_{M} including the data packets K₁, . . . , K_{M}, respectively. The CU-UP 172B generates PDU set information K₁, . . . , K_{M} for the DL data packets K₁, . . . , K_{M}, respectively, and generates CU-UP-to-DU packets K₁, . . . , K_{M} including {PDU set information K₁, the DL PDU K₁}, . . . , {PDU set information K_{M}, the DL PDU K_{M}}, respectively. The CU-UP 172B transmits the CU-UP-to-DU packets K₁, . . . , K_{M} to the DU 174. Each of the PDU set information K₁, . . . , K_{M} includes a PDU set Sequence Number. In some implementations, each of the PDU set information K₁,. K_{M} includes a PDU set Size and/or a PDU set Importance indicator. The PDU set Sequence Number, PDU set Size and/or PDU set Importance indicator in the PDU set information K₁, . . . , K_{M} are the same or identical. In some implementations, the PDU set information K_{M} includes an indication of End PDU indicating the data packet K_{M} is the last packet in the PDU set K, while the PDU set information K₁, . . . , K_{M-1} includes an indication of End PDU indicating the corresponding data packet is not the last data packet in the PDU set K. In some implementations, the CN-to-CU-UP packets K₁, . . . , K_{M} are GTP-U packets and headers of the GTP-U packets K₁, . . . , K_{M} include the PDU set information K₁, . . . , K_{M}, respectively. In some implementations, the PDU set information K₁, . . . , K_{M} include PDU Sequence Number K₁, . . . , K_{M}, respectively. The PDU Sequence Number K₁, . . . , K_{M} indicate a sequence order of the data packets K₁, . . . , K_{M} in the PDU set K. In some implementations, for a CN-to-CU-UP packet and a CU-UP-to-DU packet including the same DL data packet, (at least a portion of) the PDU set information in the CN-to-CU-UP packet is the same as or identical to (at least a portion of) the PDU set information in the CU-UP-to-DU packet. For example, PDU set Sequence Numbers, PDU set Importance indicators, and/or indications of the End PDU in the CN-to-CU-UP packet and CU-UP-to-DU packet are the same or identical. In this case, the PDU set sizes and/or PDU Sequence Numbers in the CN-to-CU-UP packet and CU-UP-to-DU packet can be the same. Alternatively, the PDU set sizes and/or PDU Sequence Numbers in the CN-to-CU-UP packet and CU-UP-to-DU packet can be different.

If the CU-UP 172B does not support PDU set based QoS handling or the third set of PDU set QoS parameters or does not enable PDU set based QoS handling, the CU-UP 172B ensures that transmission of the DL data packets satisfies the third set of non-PDU set QoS parameters or predefined QoS parameters. In this case, the CU-UP 172B does not include PDU set information in the CU-UP-to-DU packets and/or ignores PDU set information received in the CN-to-CU-UP packets. In some implementations, if the CN 110 determines that the base station 104 (e.g., the CU 172 and/or DU 174) does not support the PDU set based QoS handling, the CN 110 refrains from including PDU set information in a CN-to-CU-UP packet that includes a DL data packet for the UE 102.

After receiving 326 the DL PDUs from the CU-UP 172B, the DU 174 transmits 326 the DL PDUs to the UE 102. If the DU 174 supports PDU set based QoS handling or the second set of PDU set QoS parameters or enables PDU set based QoS handling, the DU 174 ensures that transmission of the DL PDUs satisfies the second set of PDU set QoS parameters. If the DU 174 does not support PDU set based QoS handling or the second set of PDU set QoS parameters or does not enable PDU set based QoS handling, the CU-UP 172B ensures that transmission of the DL data packets satisfy the second set of non-PDU set QoS parameters or predefined QoS parameters. The DU 174 transmits 326 the DL PDUs to the UE 102 via protocols (e.g., NR RLC 206B, NR MAC 204B and NR PHY 202B), based on the configuration parameters 316 and using resources assigned for the UE 102.

After receiving 318 the RRC reconfiguration complete message, the UE 102 transmits 326 UL data packets associated with the PDU session or QoS flow(s) to the DU 174 using the relevant protocols (e.g., NR PDCP 208, NR RLC 206B, NR MAC 204B and NR PHY 202B), using the configuration parameters. For example, for each of the UL data packets associated with the PDU session or QoS flow(s), the UE 102 generates a UL PDU (e.g., PDCP PDU or SDAP PDU) including the UL data packet and transmits UL PDU via protocols (e.g., NR RLC 206B, NR MAC 204B and NR PHY 202B). If the DU 174 supports PDU set based QoS handling or the second set of PDU set QoS parameters or enables PDU set based QoS handling, the DU 174 ensures that transmission of the UL data packets from the UE 102 (e.g., to the DU 174 or the CU-UP 172B) satisfy the second set of PDU set QoS parameters. In this case, the DU 174 can schedule the UE 102 to transmit the UL PDUs, based on the second PDU set QoS parameters. Otherwise, if the DU 174 does not support PDU set based QoS handling or the second set of PDU set QoS parameters or does not enable or disables PDU set based QoS handling, the DU 174 ensures that transmission of the UL PDUs from the UE 102 satisfies the second set of non-PDU set QoS parameters or predefined QoS parameters. In this case, the DU 174 can schedule the UE 102 to transmit the UL data packets, based on the second set of non-PDU set QoS parameters or predefined QoS parameters.

After receiving 326 the UL PDUs from the UE 102, the DU 174 transmits the UL PDUs to the CU-UP 172B. In some implementations, for each of the UL PDUs, the DU 174 generates a DU-to-CU-UP packet including the UL PDU and transmits the DU-to-CU-UP packet to the CU-UP 172B. For example, each of the DU-to-CU-UP packets is a GTP-U packet. In some implementations, the DU 174 does not include PDU set information in the DU-to-CU-UP packets. When receiving each of the DU-to-CU-UP packets, the CU-UP 172B retrieves a UL PDU from the DU-to-CU-UP packet and retrieves the UL data packet from the UL PDU. The CU-UP 172B transmits the UL data packets to the CN 110 (e.g., the UPF 162). In some implementations, to transmit each of the UL data packets to the CN 110, the CU-UP 172B generates a CU-UP-to-CN packet including one or more protocol headers and the UL data packet and transmits the CU-UP-to-CN packet to the CN 110 (e.g., the UPF 162). For example, each of the CU-UP-to-CN packets is a GTP-U packet. The protocol header(s) include an IP header, a UDP header, and/or a GTP-U header. In some implementations, if the CU-UP 172B enables PDU set based QoS handling for the PDU session or QoS flow(s) or configures the UE 102 to enable PDU set based QoS handling for the PDU session or QoS flow(s), the CU-UP 172B performs PDU set based QoS handling by grouping the UL data packets into PDU sets 1, . . . , P and transmits the PDU sets 1, . . . , P to the CN 110. For each of the UL data packets included in the CU-UP-to-CN packets, the CU-UP 172B includes (corresponding) (UL) PDU set information in the corresponding CU-UP-to-CN packet. In other implementations, the CU-UP 172B does not include PDU set information in the CU-UP-to-CN packets.

In some implementations, the UE 102 performs PDU set based QoS handling to transmit the UL data packets. In some implementations, the UE 102 performs PDU set based QoS handling by grouping the UL data packets or UL PDUs into (UL) PDU sets 1, . . . , P and transmits the PDU sets 1 . . . , P to the DU 174, where L is a positive integer and larger than one. To perform the PDU set based QoS handling, the UE 102 can include, in (e.g., a header of) in each of the UL PDUs, UL PDU set information for the respective UL PDU or UL data packet. In one implementation, the UL PDU set information for the respective UL PDU or UL data packet includes an indication of End PDU to indicate whether the UL data packet included in the respective UL PDU is the last data packet in a (UL) PDU set which the UL data packet belong to. In some implementations, the UL PDU set information additionally includes a PDU set Sequence Number, a PDU set size, and/or a PDU set Importance indication, for a UL PDU set which the respective UL PDU or UL data packet belongs to. In other implementations, the UL PDU set information does not include a PDU set Sequence Number, a PDU set size, and/or a PDU set Importance indication. In some implementations, the UL PDU set information includes a PDU Sequence Number for the corresponding UL data packet within a PDU set which the UL data packet belongs to. In other implementations, the UL PDU set information does not include a PDU Sequence Number for the corresponding UL data packet within a PDU set which the UL data packet belongs to. In some implementations, the UL PDUs are SDAP PDUs. The UE includes the UL PDU set information for each of the UL data packets in a header of the respective SDAP PDU. The UE 102 can include, in the SDAP PDU, a QoS flow identifier indicating the QoS flow which the UP data packet included in the UL PDU is associated with. For each of the SDAP PDUs, the UE 102 generates a UL PDCP PDU including the SDAP PDU and transmits the UL PDCP PDUs to the DU 174 via protocols (e.g., NR RLC 206B, NR MAC 204B and NR PHY 202B). The UE 102 includes a PDCP sequence number in each of the UL PDCP PDUs, which is different from the PDU Sequence Number in the SDAP PDUs. In other implementations, the UL PDUs are PDCP PDUs. The UE 102 includes the UL PDU set information for each of the UL data packets in a header of the respective PDCP PDU. The UE 102 transmits the PDCP PDUs to the DU 174 via protocols (e.g., NR RLC 206B, NR MAC 204B and NR PHY 202B).

For example, a (UL) PDU set L of the PDU sets 1, . . . , P includes X UL PDUs L₁, . . . , L_{X}, where L and X are positive integers and 1≤L≤P and 1≤X. The UE 102 includes UL data packets L₁, . . . , L_{X}in the UL PDUs LI, . . . , L_{X}, respectively. In the indication of End PDU in the header of the UL PDU L_{X}, the UE 102 indicates the UL data packet L_{X} is the last data packet in the PDU set L. In the indication of End PDU in the header of each of the UL PDUs L₁, . . . , L_{X-1}, the UE 102 indicates the corresponding UL data packet is not the last data packet in the PDU set L. Alternatively, the UE 102 excludes, in each of the UL PDUs L₁, . . . , L_{X-1}, the indication of End PDU indicating that the corresponding UL data packet is the last data packet in the PDU set L. In some implementations, the UE 102 includes, in the header of each of the UL PDUs L₁, . . . , L_{X-1}, a PDU set Sequence Number, a PDU set size and/or a PDU set Importance indicator for the PDU set L. The PDU set Sequence Number is L or L−1. In other implementations, the UE 102 does not include a PDU set Sequence Number, a PDU set size and/or a PDU set Importance indicator in the UL PDUs L₁, . . . , L_{X-1}. In some implementations, the UE 102 includes PDU Sequence Numbers (e.g., 0, . . . , X−1 or 1, . . . , X) in the header of the UL PDUs L₁, . . . , L_{X-1}, respectively. In other implementations, the UE 102 does not include PDU Sequence Numbers in the header of the UL PDUs L₁, . . . , L_{X-1}.

In some implementations, when the CU-UP 172B receives a UL PDU including (first) UL PDU set information and a UL data packet from the UE 102 via the DU 174 as described above, the CU-UP 172B retrieves the UL data packet from the UL PDU and generates a CU-UP-to-CN packet including the UL data packet. For example, the CU-UP-to-CN packet is a GTP-U packet. In some implementations, the CU-UP 172B includes the first UL PDU set information in a header of the CU-UP-to-CN packet. In other implementations, the CU-UP 172B generates second UL PDU set information based on the first UL PDU set information and/or other non-PDU set information, and includes the second UL PDU set information in the header of the CU-IP-to-CN packet. For example, the other information includes a sequence number in a header of the UL PDU. If the UL PDU is a PDCP PDU, the sequence number is a PDCP sequence number. In one implementation, the second UL PDU set information includes a portion of the first UL PDU set information. For example, the first UL PDU set information includes an indication of End PDU indicating whether the UL data packet is the last data packet in a PDU set and the CU-UP 172B includes the indication of End PDU in the second UL PDU set information (i.e., in the header of the CU-UP-to-packet). In another example, the first UL PDU set information includes a PDU set size for the PDU set and the CU-UP 172B includes the PDU set size in the second UL PDU set information (i.e., in the header of the CU-UP-to-packet). In the case that the UL PDU or the first UL PDU set information does not include a PDU set Sequence Number, the CU-UP 172B can generate a PDU set Sequence Number for the PDU set and include the PDU set Sequence Number in the second UL PDU set information. In the case that the UL PDU or the first UL PDU set information does not include a PDU Sequence Number for the UL PDU, the CU-UP 172B can generate a PDU Sequence Number for the UL data packet based on the sequence number (e.g., PDCP sequence number) in the header of the UL PDU and include the PDU Sequence Number in the second UL PDU set information. In the case that the first PDU set information does not include a PDU set Importance indicator, the CU-UP 172B sets a PDU set Importance indicator to a predetermined value and include the PDU set Importance indicator in the second PDU set information. In other implementations, the CU-UP 172B sets the PDU set Importance indicator to a value, based on the first set of PDU set QoS parameters, and includes the PDU set Importance indicator in the second PDU set information. In some implementations, if the first PDU set information does not include a PDU set size, the CU-UP 172B can not include a PDU set size in the second PDU set information. Alternatively, the CU-UP 172B can set a PDU set size to a predetermined value and incudes the PDT Set size in the second PDU set information.

For example, the UE 102 groups UL data packets into the UL PDU set 1 and UL PDU set 2. The UL PDU set 1 incudes Y UL PDUs 1₁, . . . , 1_{Y} including UL data packets 1₁, . . . , 1_{Y}, respectively. Y is a positive integer and 1≤Y. The UL PDU set 2 incudes Z UL PDUs 2₁, . . . , 2_{Z} including UL data packets 2₁, . . . , 2%, respectively. Z is a positive integer and 1≤Z. The UE 102 assigns sequence numbers (e.g., PDCP sequence numbers) 1₁, . . . , 1_{Y}, and 2₁, . . . , 2_{Z} for the UL PDUs or UL data packets 1₁, . . . , 1_{Y}, and 2₁, . . . , 2_{Z} in ascending order, respectively. The UE 102 includes sequence numbers 1₁, . . . , 1_{Y}, and 2₁, . . . , 2_{Z} in the UL PDUs 1₁, . . . , 1_{Y}, and 2₁, . . . , 2_{Z}, respectively. The UE 102 transmits the Y UL PDUs and Z UL PDUs to the CU-UP 172B via the DU 174. In some implementations, the UE 102 does not include a PDU set Sequence Number in the UL PDUs 1₁, . . . , 1_{Y}, and 2₁, . . . , 2_{Z}. The UE 102 includes an indication of End PDU in a header of the UL PDU 1_{Y} to indicate that the UL data packet in the UL PDU 1_{Y} is the last data packet of the PDU set 1. In each of the UL PDUs 1₁, . . . , 1_{Y-1}, the UE 102 includes an indication of End PDU to indicate that the included UL data packet is not the last data packet of the PDU set 1. Alternatively, in each of the UL PDUs 1₁, . . . , 1_{Y-1}, the UE 102 excludes the indication of End PDU indicating that the included UL data packet is the last data packet. The UE 102 includes an indication of End PDU in a header of the UL PDU 2_{Z} to indicate that the UL data packet in the UL PDU 2_{Z} is the last data packet of the PDU set 2. In each of the UL PDUs 2₁, . . . , 2_{Z-1}, the UE 102 includes an indication of End PDU to indicate that the included UL data packet is not the last data packet of the PDU set 2. Alternatively, in each of the UL PDUs 2₁, . . . , 2_{Z-1}, the UE 102 excludes the indication of End PDU indicating that the included UL data packet is the last data packet.

When the CU-UP 172B receives the UL PDUs 1₁, . . . , 1_{Y}, the CU-UP 172B determines the UL PDUs belongs to a first PDU set and determines a PDU set Number 1 (e.g., the value=‘0’) for the first PDU set. The CU-UP 172B retrieves the UL data packets 1₁, . . . , 1_{Y} from the UL PDUs 1₁, . . . , 1_{Y}, respectively. The CU-UP 172B generates CU-UP-to-CN packets 1₁, . . . , 1_{Y} including the UL PDUs 1₁, . . . , 1_{Y} and includes the PDU set Number 1 in the header of the CU-UP-to-CN packets 1₁, . . . , 1%, respectively. The CU-UP 172B transmits the CU-UP-to-CN packets 1₁, . . . , 1_{Y} to the CN 110 (e.g., UPF 162). The CU-UP 172B. When the CU-UP 172B receives the UL PDU 1_{Y} and a header of the UL PDU includes an indication of End PDU indicating that the included UL data packet is the last data packet, the CU-UP 172B can determine that UL PDU(s) with a sequence number before a sequence number of the UL PDU 1_{Y} belong to the first PDU set. Before or after receiving the UL PDU 1_{Y}, the CU-UP 172B receives the UL PDUs 2₁, . . . , 2_{Z} and retrieves the UL data packets 2₁, . . . , 2_{Z} from the UL PDUs 2₁, . . . , 2_{Z}. After receiving the UL PDU 1_{Y}, the CU-UP 172B determines the UL PDUs or UL data packets 2₁, . . . , 2_{Z} belong to a different PDU set (i.e., a second PDU set) and determines a PDU set Number 2 (e.g., the value=‘2’) for the second PDU set. The CU-UP 172B generates CU-UP-to-CN packets 2₁, . . . , 2_{Z} including the UL PDUs 2₁, . . . , 2_{Z} and includes the PDU set Number 2 in the header of the CU-UP-to-CN packets 2₁, . . . , 2_{Z}, respectively. The CU-UP 172B transmits the CU-UP-to-CN packets 2₁, . . . , 2_{Z} to the CN 110.

In some implementations, the CU-UP 172B determines whether to discard a PDU set received from the CN 110 or UE 102, based on a PDU set Importance indication for the PDU set. For example, in cases where the CU-UP 172B is congested or has no sufficient resources, if the PDU set Importance indication is set to a first value, the CU-UP 172B discards the PDU set, e.g., because the CU-UP 172B cannot make transmission of the PDU set satisfy the third set of PDU set QoS parameters. Otherwise, if the PDU set Importance indication is set to a second value, the CU-UP 172B refrain from discarding or does not discard the PDU set.

In some implementations, the UE 102 does not perform PDU set based QoS handling to transmit the UL data packets. In such cases, the UE 102 does not include or refrains from including PDU set information in the UL PDUs.

In some implementations, the CN 110 enables 325 PDU set based QoS handling for the PDU session or QoS flow(s), after (e.g., in response to) receiving the PDU Session Resource Response message. In other implementations, the CN 110 enables 325 PDU set based QoS handling for the PDU session or QoS flow(s), regardless of whether or before receiving the PDU Session Resource Response message. In some implementations, the CU-UP 172B enables 324 PDU set based QoS handling for the PDU session or QoS flow(s), in response to receiving 312 the PDU Session Resource Request message or the first set of PDU set QoS parameters. In some implementations, if the CU 172 receives a PDU Session Resource Release Command message for the PDU session from the CN 110, the CU 172 disables PDU set based QoS handling for the PDU session or QoS flow. In some implementations, if the CU 172 receives a PDU Session Resource Modify Request message releasing the QoS flow from the CN 110, the CU 172 disables PDU set based QoS handling for the QoS flow. In some implementations, if the CU 172 receives a PDU Session Resource Request message (e.g., a PDU Session Resource Setup Request message or a PDU Session Resource Modify Request message) from the CN 110, excluding PDU set QoS parameters, for a PDU session or a QoS flow for a UE (e.g., the UE 102 or another UE), the CU 172 disables or refrains from enabling PDU set based QoS handling for the PDU session or QoS flow. In some implementations, the CU-CP 172A can include, in the Bearer Context Request message, a configuration parameter enabling or configuring PDU set based QoS handling for the UE 102, PDU session and/or QoS flow(s). In some implementations, the CU-UP 172B enables 324 PDU set based QoS handling for the PDU session or QoS flow, in response to receiving the Bearer Context Request message, the third set of PDU set QoS parameters, or the configuration parameter enabling or configuring PDU set based QoS handling. In some implementations, if the CU-UP 172B receives a Bearer Context Release Command message or a Bearer Context Modification Request message to release a bearer context for the PDU session or QoS flow from the CU-CP 172A, the CU-UP 172B disables or refrains from enabling PDU set based QoS handling for the PDU session or QoS flow. In some implementations, if the CU-UP 172B receives a Bearer Context Request message (e.g., a Bearer Context Setup Request message or a Bearer Context Modification Request message) from the CN 110, excluding PDU set QoS parameters, for a PDU session or a QoS flow for a UE (e.g., the UE 102 or another UE), the CU-UP 172B 172 disables or refrains from enabling PDU set based QoS handling for the PDU session or QoS flow.

The events depicted in FIG. 3 collectively can be referred as a PDU set based data communication 390.

Referring next to FIG. 4, in a scenario 400, the base station 104 includes a CU 172, a DU 174A, and a DU 174B. The CU 172 in some cases includes a CU-CP 172A and a CU-CP 172B, as shown in FIG. 1B. Initially, the CN 110, CU 172, DU 174A and UE 102 perform 490 PDU set based data communication for a PDU session or a QoS flow, similar to the PDU set based data communication 390. During the communication 490, the CU 172 (e.g., the CU-CP 172A) can receive a first set of PDU set QoS parameters and/or a first set of non-PDU set QoS parameters for the PDU Session or QoS flow from the CN 110 and/or transmit a second set of PDU set QoS parameters and/or a second set of non-PDU set QoS parameters for the PDU Session or QoS flow to the DU 174A, similar to the event 312 and/or event 313, respectively. During the communication 490, the CU-CP 172A can transmit a third set of PDU set QoS parameters and/or a third set of non-PDU set QoS parameters for the PDU Session or QoS flow to the CU-CP 172B, similar to the event 315.

At a later time, the CU 172 (e.g., CU-CP 172A) determines to prepare a handover (e.g., an immediate handover or a conditional handover (CHO)) for the UE 102 to the DU 174B. In some implementations, the CU 172 makes the determination based on measurement results received from the UE 102 via the DU 174A. In response to the determination, the CU 172 transmits 413 a UE Context Request message to the DU 174B to prepare the handover. In response, the DU 174B transmits 414 a UE Context Response message to the CU 172. In case of the conditional handover, the CU 172 can include a CHO indication (e.g., CHO-initiation) in the UE Context Request message. In case of the immediate handover, the CU 172 can exclude the CHO indication from the UE Context Request message.

In some implementations, the CU 172 includes a fourth set of PDU set QoS parameters and/or a fourth set non-PDU set QoS parameters for the PDU Session or QoS flow in the UE Context Request message, similar to including the second set of PDU set QoS parameters and the second set of non-PDU set QoS parameters in the UE Context Request message 313. In some implementations, the fourth set of PDU set QoS parameters is the same as or identical to the first set of PDU set QoS parameters. In other implementations, the fourth set of PDU set QoS parameters is different from the first set of PDU set QoS parameters. For example, the CU 172 determines the fourth set of PDU set QoS parameters based on the first set of PDU set QoS parameters, similar to determining the second set of PDU set QoS parameters based on the first set of PDU set QoS parameters as described for FIG. 3. In another example, the fourth set of PDU set QoS parameters is the same as or identical to the second or third set of PDU set QoS parameters. In some implementations, the fourth set of non-PDU set QoS parameters is the same as or identical to the first set of non-PDU set QoS parameters. In other implementations, the fourth set of non-PDU set QoS parameters is different from the first set of non-PDU set QoS parameters. For example, the CU 172 determines the fourth set of non-PDU set QoS parameters based on the first set of non-PDU set QoS parameters, similar to determining the second set of (non-)PDU set QoS parameters based on the first set of (non-)PDU set QoS parameters as described for FIG. 3. In another example, the fourth set of non-PDU set QoS parameters is the same as or identical to the second or third set of non-PDU set QoS parameters. Examples and implementations described for the second set of PDU set QoS parameters and/or the second set of non-PDU set QoS parameters for FIG. 3 apply to the fourth set of PDU set QoS parameters and the fourth set of non-PDU set QoS parameters, respectively.

In some implementations, after (e.g., in response to) receiving 413 the UE Context Request message, the DU 174B enables 422 PDU set based QoS handling for data communicated with the CU 172, similar to the event 322. For example, the DU 174B enables PDU set based QoS handling after (e.g., in response to) receiving 413 the UE Context Request message, if the DU 174B supports PDU set based QoS handling or the fourth set of PDU set QoS parameters.

In some implementations, the CU 172 (e.g., CU-CP 172A) includes UL transport layer information in the UE Context Request message. The UL transport layer information configures a tunnel for the DU 174B to transmit UL PDUs received from the UE 102 to the CU 172 (e.g., CU-UP 172B) in the event 426. The CU-CP 172A can receive the UL transport layer information from the CU-UP 172B in a Bearer Context Setup procedure in the communication 490, similar to the procedure 392. In some implementations, the DU 174B includes 414 DL transport layer information in the UE Context Response message. In some implementations, the DL transport layer information configures a tunnel (e.g., GTP-U tunnel) for the CU 172 (e.g., CU-UP 172B) to transmit DL PDUs for the UE 102 to the DU 174B in the event 426. In the case that the CU 172 includes the CU-CP 172A and CU-UP 172B, the CU-CP 172A performs 492 a Bearer Context Modification procedure with the CU-UP 172B, after receiving 414 the UE Context Response message. In the Bearer Context Modification procedure, the CU-CP 172A transmits a Bearer Context Modification Request message to the CU-UP 172B, and in response, the CU-UP 172B transmits a Bearer Context Modification Response message. In some implementations, the CU-CP 172A includes the DL transport layer information in the Bearer Context Modification Request message. In case of the conditional handover, the CU-CP 172A can include a CHO indication (e.g., CHO-initiation) in the Bearer Context Modification Request message. In case of the immediate handover, the CU 172 can exclude the CHO indication from the Bearer Context Modification Request message.

After receiving 414 the UE Context Response message and/or perform 492 the Bearer Context Modification procedure, the CU 172 (e.g., CU-CP 172A) generates a first RRC reconfiguration message including configuration parameters for the UE 102. In some implementations, the configuration parameters include a measurement configuration, one or more DRB configurations, one or more CU configuration parameters and/or DU configuration parameters as described for the event 316. In one implementation, the UE Context Response message of event 414 includes the DU configuration parameters. In case of the immediate handover, the CU 172 transmits 416 the first RRC reconfiguration message to the UE 102 via the DU 174A. In response to receiving the first RRC reconfiguration message, the UE 102 attempts to access a cell (e.g., the cell 125) operated by the DU 174B and transmits 418 a first RRC reconfiguration complete message to the CU 172 via the cell and DU 174B. In case of the conditional handover, the CU 172 includes the first RRC reconfiguration and a trigger condition configuration in a container, includes the container in a second RRC reconfiguration message and transmits 416 the second RRC reconfiguration message to the UE 102 via the DU 174A. In response to receiving the second RRC reconfiguration message, the UE 102 transmits a second RRC reconfiguration complete message to the CU 172 via the DU 174A. For example, the container is a CondReconfigToAddMod information element (IE). The trigger condition configuration configures one or more trigger conditions for executing the first RRC reconfiguration message. At a later time, when the UE 102 detects that the trigger condition(s) is/are satisfied, the UE 102 executes the first RRC reconfiguration message. Upon executing the first RRC reconfiguration message, the UE 102 access the cell and transmits 418 the first RRC reconfiguration complete message to the CU 172 via the cell and DU 174B.

After receiving the first RRC reconfiguration complete message, the CU 172 communicates 426 data with the UE 102 via the DU 174B, where the CU 172 communicates the data with the CN 110. In some implementations, after receiving the first RRC reconfiguration message, the CU 172 can transmit 436 a UE Context Release Command message to the DU 174A to release a UE Context and resources that the DU 174A configures for the UE 102. In response, the DU 174A releases the UE Context and resources and can transmit a UE Context Release Complete message to the CU 172.

Referring now to FIG. 5A, in a scenario 500A, the target base station (T-BS) 104 includes a CU 172 and a DU 174. The CU 172 can include a CU-CP 172A and a CU-CP 172B as shown in FIG. 1B. Initially, the CN 110, source base station (S-BS) 106 and UE 102 perform 590 PDU set based data communication for a PDU Session or a QoS flow, similar to the PDU set based data communication 390 or 490. The S-BS 106 can include a CU and a DU and the CU can include a CU-CP and a CU-UP. In the communication 590, the S-BS 106 can receive a first set of PDU set QoS parameters and/or a first set of non-PDU set QoS parameters for the PDU Session or QoS flow from the CN 110, similar to the event 312. In the communication 590, the CU or CU-CP of the S-BS 106 can transmit a second set of PDU set QoS parameters and/or a second set of non-PDU set QoS parameters for the PDU Session or QoS flow to the DU of the S-BS 106, similar to the event 313. In the communication 590, the CU-CP 172A can transmit a third set of PDU set QoS parameters and/or a third set of non-PDU set QoS parameters for the PDU Session or QoS flow to the CU-CP 172B, similar to the event 315.

At a later time, the S-BS 106 (e.g., CU or CU-CP) determines to prepare a handover (e.g., an immediate handover or a CHO) for the UE 102 to the T-BS 104. In some implementations, the S-BS 106 makes the determination based on measurement results received from the UE 102. In response to the determination, the S-BS 106 transmits 528 a Handover Request message to the T-BS 104 (e.g., the CU 172 or CU-CP 172A) to prepare the handover. In case of the conditional handover, the S-BS 106 can include a CHO indication (e.g., CHO-initiation) in the Handover Request message. In case of the immediate handover, the CU 172 can exclude the CHO indication from the Handover Request message.

In some implementations, the S-BS 106 includes, in the Handover Request message, a PDU session ID and/or a QoS flow identifier identifying the PDU session and/or QoS flow, respectively. In some implementations, the S-BS 106 includes a fourth set of PDU set QoS parameters and/or a fourth set non-PDU set QoS parameters for the PDU Session or QoS flow in the Handover Request message. In some implementations, the fourth set of PDU set QoS parameters is the same as or identical to the first set of PDU set QoS parameters. In other implementations, the fourth set of PDU set QoS parameters is different from the first set of PDU set QoS parameters. For example, the S-BS 106 determines the fourth set of PDU set QoS parameters based on the first set of PDU set QoS parameters, similar to determining the second set of PDU set QoS parameters as described for FIG. 3. In another example, the fourth set of PDU set QoS parameters is the same as or identical to the second or third set of PDU set QoS parameters. In some implementations, the fourth set of non-PDU set QoS parameters is the same as or identical to the first set of non-PDU set QoS parameters. In other implementations, the fourth set of PDU set QoS parameters is different from the first set of non-PDU set QoS parameters. For example, the S-BS 106 determines the fourth set of PDU set QoS parameters based on the first set of non-PDU set QoS parameters, similar to determining the second set of non-PDU set QoS parameters based on the first set of non-PDU set QoS parameters as described for FIG. 3. In another example, the fourth set of non-PDU set QoS parameters is the same as or identical to the second or third set of non-PDU set QoS parameters.

After receiving (e.g., in response to) receiving 528 the Handover Request message, the CU 172 transmits 513 a UE Context Request message to the DU 174. In response, the DU 174 transmits 514 a UE Context Response message to the CU 172. In some implementations, the DU 174 includes DL transport layer information in the UE Context Response message. In some implementations, the DL transport layer information configures a tunnel (e.g., GTP-U tunnel) for the CU 172 (e.g., CU-UP 172B) to transmit DL PDUs for the UE 102 to the DU 174 in the event 526. In case of the conditional handover, the CU 172 can include a CHO indication (e.g., CHO-initiation) in the UE Context Request message. In case of the immediate handover, the CU 172 can exclude the CHO indication from the UE Context Request message.

In some implementations, the CU 172 (e.g., CU-CP 172A) includes 514 a fifth set of PDU set QoS parameters and/or a fifth set non-PDU set QoS parameters for the PDU Session or QoS flow in the UE Context Request message, similar 313 to including the second set of PDU set QoS parameters and the second set of non-PDU set QoS parameters in the UE Context Request message. In some implementations, the fifth set of PDU set QoS parameters is the same as or identical to the fourth set of PDU set QoS parameters. In other implementations, the fifth set of PDU set QoS parameters is different from the fourth set of PDU set QoS parameters. For example, the CU 172 determines the fifth set of PDU set QoS parameters based on the fourth set of PDU set QoS parameters, similar to determining the second set of PDU set QoS parameters based on the first set of QoS parameters as described for FIG. 3. In some implementations, the fifth set of non-PDU set QoS parameters is the same as or identical to the fourth set of non-PDU set QoS parameters. In other implementations, the fifth set of non-PDU set QoS parameters is different from the fourth set of non-PDU set QoS parameters. For example, the CU 172 determines the fifth set of non-PDU set QoS parameters based on the fourth set of non-PDU set QoS parameters, similar to determining the second set of (non-)PDU set QoS parameters based on the first set of (non-)PDU QoS parameters as described for FIG. 3. The example implementations discussed in connection with the second set of PDU set QoS parameters and/or the second set of non-PDU set QoS parameters with reference to FIG. 3 also can apply to the fifth set of PDU set QoS parameters and the fifth set of non-PDU set QoS parameters, respectively.

In some implementations, after receiving 528 (e.g., in response to) receiving the Handover Request message and before transmitting 513 the UE Context Request message, the CU-CP 172A can perform 591 a Bearer Context Setup procedure with the CU-UP 172B to establish a bearer context for the UE 102, similar to the event 392 and/or 492. In the Bearer Context Setup procedure, the CU-CP 172A transmits a Bearer Context Setup Request message to the CU-UP 172B. In response, the CU-UP 172B transmits a Bearer Context Setup Response message to the CU-CP 172A. The CU-CP 172A can transmit 513 the UE Context Request message after completing the Bearer Context Setup procedure. In some implementations, the CU includes UL transport layer information in the UE Context Request message. The CU-CP 172A can receive UL transport layer information from the CU-UP 172B in the Bearer Context Setup Response message. The UL transport layer information configures a tunnel for the DU 174 to transmit UL PDUs received from the UE 102 to the CU 172 (e.g., CU-UP 172B) in the event 526.

After receiving 514 the UE Context Response message, the CU-CP 172A can perform a Bearer Context Modification procedure with the CU-CP 172B. In the Bearer Context Modification procedure, the CU-CP 172A transmits a Bearer Context Modification Request message to the CU-UP 172B and in response, the CU-UP 172B transmits a Bearer Context Modification Response message to the CU-CP 172A. In some implementations, the CU-CP 172A includes the DL transport layer information in the Bearer Context Modification Request message. After receiving 514 the UE Context Response message, the CU 172 (e.g., CU-CP 172A) generates a first RRC reconfiguration message including configuration parameters for the UE 102. In some implementations, the configuration parameters include a measurement configuration, one or more DRB configurations, one or more CU configuration parameters and/or DU configuration parameters as described for the events 316 and/or 416. In one implementation, the UE Context Response message 514 includes the DU configuration parameters. The CU 172 transmits 530 a Handover Request Acknowledge message including the first RRC reconfiguration message to the S-BS 106. In some implementations, the CU-CP 172A transmits 530 the Handover Request Acknowledge message e.g., before or after performing the procedure 592.

In some implementations, the CU-CP 172A includes 591 a sixth set of PDU set QoS parameters and/or a sixth set non-PDU set QoS parameters for the PDU Session or QoS flow in the Bearer Context Setup Request message and/or Bearer Context Modification Request message, similar to including 315 the third set of PDU set QoS parameters and the third set of non-PDU set QoS parameters in the UE Context Request message. In some implementations, the sixth set of PDU set QoS parameters is the same as or identical to the fourth set of PDU set QoS parameters. In other implementations, the sixth set of PDU set QoS parameters is different from the fourth set of PDU set QoS parameters. For example, the CU-CP 172A determines the sixth set of PDU set QoS parameters based on the fourth set of PDU set QoS parameters, similar to determining the third set of PDU set QoS parameters based on the first set of QoS parameters as described for FIG. 3. In some implementations, the sixth set of non-PDU set QoS parameters is the same as or identical to the fourth set of non-PDU set QoS parameters. In other implementations, the sixth set of non-PDU set QoS parameters is different from the fourth set of non-PDU set QoS parameters. For example, the CU-CP 172A determines the sixth set of non-PDU set QoS parameters based on the fourth set of non-PDU set QoS parameters, similar to determining the third set of (non-)PDU set QoS parameters based on the first set of (non-)PDU set QoS parameters as described for FIG. 3. The example implementations discussed in connection with the third set of PDU set QoS parameters and/or the third set of non-PDU set QoS parameters with reference to FIG. 3 also can apply to the sixth set of PDU set QoS parameters and the sixth set of non-PDU set QoS parameters, respectively.

In some implementations, after (e.g., in response to) receiving 513 the UE Context Request message, the DU 174 enables 522 PDU set based QoS handling for data communicated with the CU 172, similar to the event 322. In some implementations, after (e.g., in response to) receiving 528 the Handover Request message, the CU 172 enables 524 PDU set based QoS handling for data communicated with the CN 110, similar to the event 324. In other implementations, after (e.g., in response to) receiving the Bearer Context Setup Request message 591 or Bearer Context Modification Request message 592, the CU-UP 172B enables 524 PDU set based QoS handling for data communicated with the CN 110, similar to the event 324.

In case of the immediate handover, the S-BS 106 transmits 516 the first RRC reconfiguration message to the UE 102. In response, the UE 102 attempts to access a cell (e.g., the cell 125) operated by the DU 174B and transmits 518 a first RRC reconfiguration complete message to the CU 172 via the cell and DU 174. In case of the conditional handover, the S-BS 106 includes the first RRC reconfiguration and a trigger condition configuration in a container, includes the container in a second RRC reconfiguration message and transmits 516 the second RRC reconfiguration message to the UE 102. In response to receiving the second RRC reconfiguration message, the UE 102 transmits a second RRC reconfiguration complete message to the S-BS 106. For example, the container is a CondReconfigToAddMod information element (IE). The trigger condition configuration configures one or more trigger conditions for executing the first RRC reconfiguration message. At a later time, when the UE 102 detects the trigger condition(s), the UE 102 executes the first RRC reconfiguration message. Upon executing the first RRC reconfiguration message, the UE 102 access the cell and transmits 518 the first RRC reconfiguration complete message to the CU 172 via the cell and DU 174.

In some implementations, the UE 102 receives one or more configurations for PDU set based QoS handling from the S-BS 106 in the communication 590. If the T-BS 104 (e.g., the CU 172, CU-CP 172A, CU-UP 172B and/or DU 174) does not support PDU set based QoS handling, the CU 172 (e.g., CU-CP 172A) configures the UE 102 to release the configuration(s) for PDU set based QoS handling in the first RRC reconfiguration message. The UE 102 releases the configuration(s) in response to receiving the first RRC reconfiguration message. The UE 102 disables 521 PDU set based QoS handling in response to releasing the configuration(s). Otherwise, if the T-BS 104 (e.g., the CU 172, CU-CP 172A, CU-UP 172B and/or DU 174) supports PDU set based QoS handling, the CU 172 (e.g., CU-CP 172A) configures the UE 102 to continues applying the configuration(s) for PDU set based QoS handling in the first RRC reconfiguration message. The UE 102 continues applying the configuration(s) in response to receiving the first RRC reconfiguration message. The UE 102 continues enabling 521 PDU set based QoS handling in response to receiving the first RRC reconfiguration message. Alternatively, if the T-BS 104 (e.g., the CU 172, CU-CP 172A, CU-UP 172B and/or DU 174) supports PDU set based QoS handling, the CU 172 (e.g., CU-CP 172A) includes one or more new configurations for PDU Se based QoS handling to update the configuration(s) in the first RRC reconfiguration. The UE 102 updates the configuration(s) with the new configuration(s) upon receiving the first RRC reconfiguration message. The UE 102 continues enabling 521 PDU set based QoS handling in response to receiving the first RRC reconfiguration message or new configuration(s).

After receiving 518 the first RRC reconfiguration complete message, the CU 172 (e.g., CU-CP 172A transmits 532 a Path Switch Request message to the CN 110 to request the CN 110 to switch a connection path from the S-BS 106 to the CU 172. In response, the CN 110 switches a communication path (e.g., NG connection) from the S-BS 106 to the CU 172 and transmits 534 a Path Switch Request Acknowledge message to the CU 172. After receiving the first RRC reconfiguration complete message or the Path Switch Request Acknowledge message, the CU 172 transmits 536 a UE Context Release message to the S-BS 106 to release a UE Context of the UE 102. In response, the S-BS 106 releases the UE Context of the UE 102. After receiving the first RRC reconfiguration complete message or the Path Switch Request Acknowledge message, the CU 172 communicates 526 data with the UE 102 via the DU 174, where the CU 172 communicates the data with the CN 110.

In some implementations, the CN 110 includes a seventh set of PDU set QoS parameters and/or a seventh set of non-PDU set QoS parameters for the PDU Session or QoS flow in the Path Switch Request Acknowledge message, similar to the event 312. After receiving the seventh set of PDU set QoS parameters and/or the seventh set of non-PDU set QoS parameters, the CU 172 (e.g., CU-CP 172A) can perform a UE Context procedure (similar to the events 313 and 314), a Bearer Context procedure (similar to the events 315 and 317) and/or a RRC reconfiguration procedure (similar to the events 316 and 318) with the DU 174, CU-CP 174B and/or the UE 102 respectively.

FIG. 5B is a scenario 500B similar to the scenario 500A, except that the S-BS 106 prepares a handover for the UE 102 with the T-BS 104 via the CN 110 rather than with the T-BS 104 directly. In response to determining to hand UE 102 over to the base station 104, the S-BS 106 transmits 527 a Handover Required message to the CN 110 (e.g., AMF 164) to prepare the handover. After (e.g., in response to) receiving the Handover Required message, the CN 110 transmits 529 a Handover Request message to the CU 172 to request the handover for the UE 102. In some implementations, the S-BS 106 includes, in the Handover Required message, a PDU session ID and/or a QoS flow identifier identifying the PDU session and/or QoS flow, respectively. In some implementations, the CN 110 includes the PDU session ID and/or the QoS flow identifier in the Handover Request message.

Because the PDU set QoS parameters generally originate at the CN 110, in most scenarios there is no need for the S-BS 106 to include the PDU set QoS parameters in the Handover Required message. However, in some implementations, the S-BS 106 includes the fourth set of PDU set QoS parameters and/or the fourth set non-PDU set QoS parameters for the PDU Session or QoS flow in the Handover Required message. In such implementations, the CU 172 includes the fourth set of PDU set QoS parameters and/or the fourth set non-PDU set QoS parameters for the PDU Session or QoS flow in the Handover Request message. In another implementation, the S-BS 106 omits the PDU set QoS parameters from the Handover Required message, and the CN 110 determines the PDU set QoS parameters for the target base station based on the configuration which the CN 110 previously provided to the S-BS 106.

After receiving (e.g., in response to) receiving 529 the Handover Request message, the CU 172 performs 513, 514 the UE Context procedure with the DU 174. After (e.g., in response to) receiving 529 the Handover Request message, the CU-CP 172A performs 591 the Bearer Context Setup procedure with the CU-UP 172B. After performing 513, 514 the UE Context procedure, the CU-CP 172A performs 592 the Bearer Context Modification procedure with the CU-UP 174B. After receiving 514 the UE Context Response message or performing 592 the Bearer Context Modification procedure, the CU 172 transmits 531 a Handover Request Acknowledge message including the first RRC reconfiguration message to the CN 110 (e.g., AMF 164). After receiving the Handover Request Acknowledge message, the CN 110 transmits 533 a Handover Command message including the first RRC reconfiguration message to the S-BS 106.

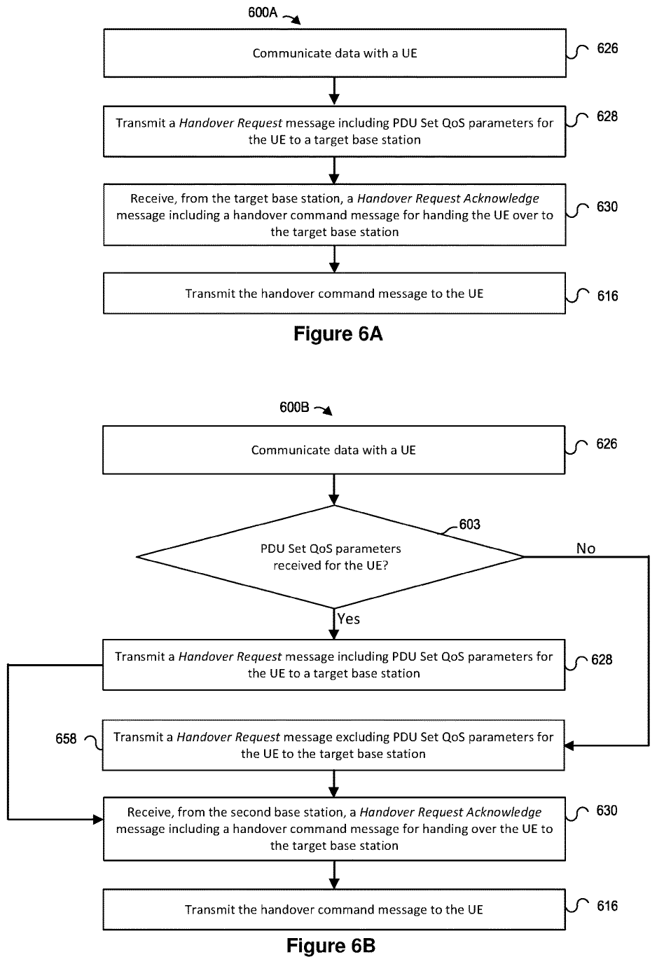

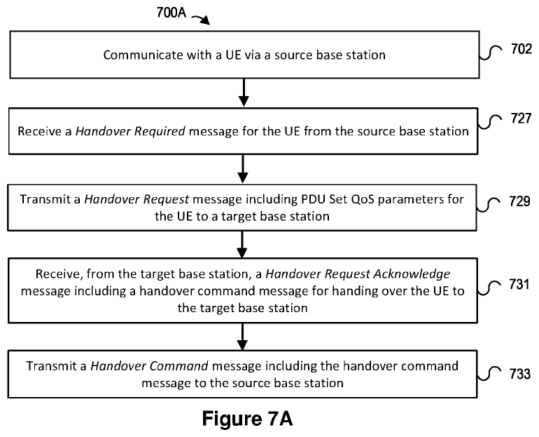

FIG. 6A is a flow diagram of an example method 600A for performing PDU set based QoS handling on data for a UE (e.g., the UE 102), which can be implemented by a source base station (e.g., the base station 104 or 106).

The method 600A begins at block 626, where the source base station communicates data with a UE (e.g., events 326, 426, 526). In some implementations, the data is associated with a PDU session or a QoS flow. At block 628, the source base station transmits a Handover Request message including PDU set QoS parameters for the UE to a target base station (e.g., event 528). In some implementations, the PDU set QoS parameters are associated with the PDU session or the QoS flow. At block 630, the source base station receives, from the second base station, a Handover Request Acknowledge message including a handover command message for handing over the UE to the target base station (e.g., event 530). In some implementations, the handover command message is a RRC reconfiguration message. At block 616, the source base station transmits the handover command message to the UE (e.g., event 516).

FIG. 6B is a flow diagram of an example method 600B similar to the method 600A, except that method 600B includes blocks 603 and 658. At block 603, the source base station determines whether the source base station receives PDU set QoS parameters for the UE. If the source base station determines that the source base station receives PDU set QoS parameters for the UE at block 603, the flow proceeds to block 628. Otherwise, if the source base station determines that the source base station does not receive PDU set QoS parameters for the UE at block 603, the flow proceeds to block 658, where the source base station transmits a Handover Request message excluding PDU set QoS parameters for the PDU session or the QoS flow to the target base station. The flow proceeds from block 629 to block 630.

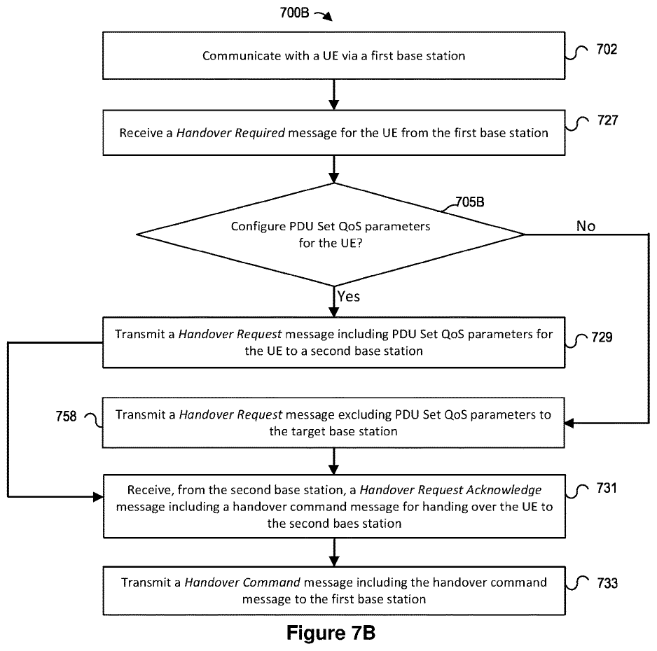

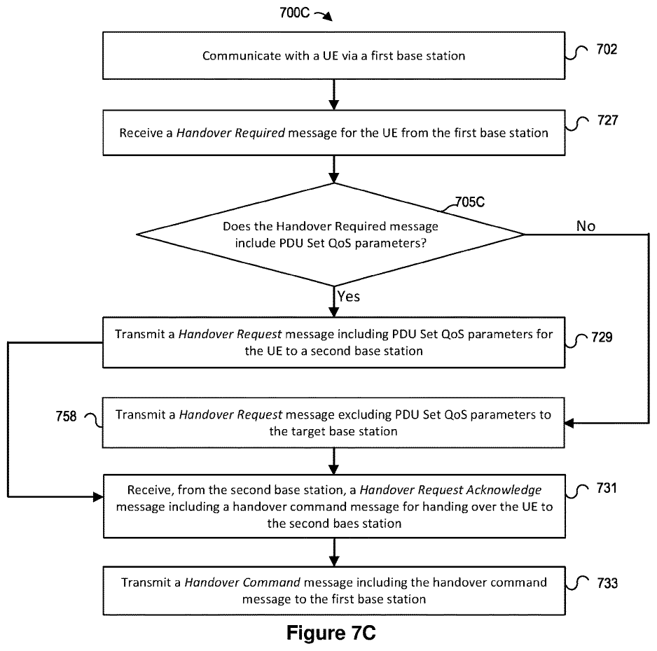

FIG. 7A is a flow diagram of an example method 700A for performing PDU set based QoS handling on data for a UE (e.g., the UE 102), which can be implemented by a CN (e.g., the CN 110).

The method 700A begins at block 702, where the CN communicates with a UE via a first (source) RAN node or base station (e.g., events 302, 304, 390, 490, 590). In some implementations, the data is associated with a PDU session or a QoS flow. At block 727, the CN receives a Handover Required message from the first base station (e.g., event 527). At block 729, the CN transmits a Handover Request message including PDU set QoS parameters for the UE to a second (target) RAN node or base station (e.g., event 529). In some implementations, the PDU set QoS parameters are associated with the PDU session or the QoS flow. At block 731, the CN receives, from the second base station, a Handover Request Acknowledge message including a handover command message for handing over the UE to the target base station (e.g., event 531). In some implementations, the handover command message is a RRC reconfiguration message. At block 733, the CN transmits a Handover Command message including the handover command message to the first base station (e.g., event 533).

Generally speaking, the CN need not always provide the same PDU set QoS parameters to the source and target base stations. For example, the CN can determine that the memory and/or processing capabilities of the target base station allow for a different (e.g., less stringent, more stringent) set of PDU set QoS parameters. In some implementations, however, the CN simply provides the same PDU set QoS parameters to the source base station and the target base station.

FIG. 7B is a flow diagram of an example method 700B similar to the method 700A, except that method 700B includes blocks 705B and 758. At block 705B, the CN determines whether the CN configures PDU set QoS parameters the UE. If the CN determines that the CN configures PDU set QoS parameters for the UE at block 705B, the flow proceeds to block 729. Otherwise, if the CN determines that the CN does not configure PDU set QoS parameters for the UE, the flow proceeds to block 758, where the CN transmits a Handover Request message excluding PDU set QoS parameters to the target base station. The flow proceeds from block 758 to block 731 and then to block 733.

FIG. 7C is a flow diagram of an example method 700C similar to the methods 700A and 700B, except that method 700C includes block 705C instead of block 705B. At block 705C, the CN determines whether the Handover Required message includes PDU set QoS parameters the UE. If the Handover Required message includes PDU set QoS parameters for the UE at block 705C, the flow proceeds to block 729. Otherwise, if the Handover Required message does not include PDU set QoS parameters for the UE at block 705C, the flow proceeds to block 758.

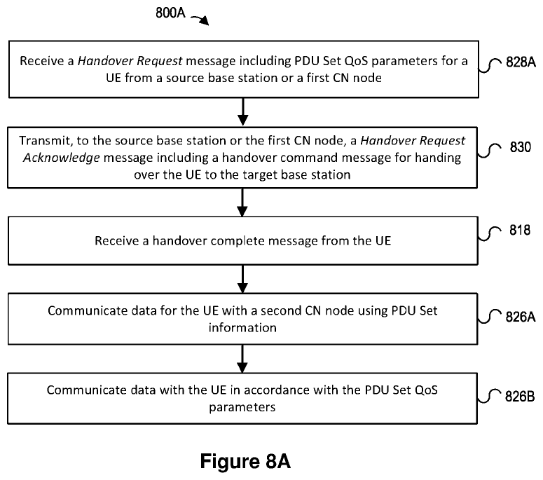

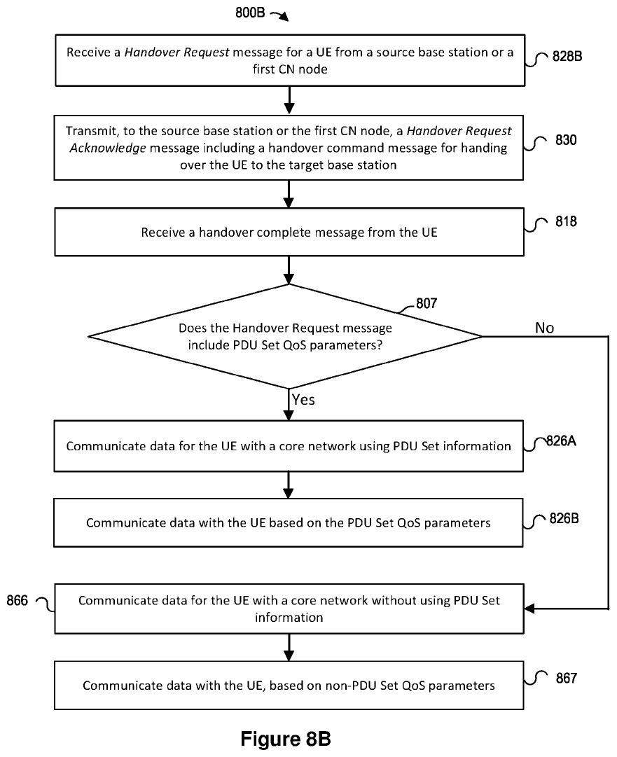

FIG. 8A is a flow diagram of an example method 800A for performing PDU set based QoS handling on data for a UE (e.g., the UE 102), which can be implemented by a target base station (e.g., the base station 104 or 106).

The method 800A begins at block 828A, where the target base station receives a Handover Request message including PDU set QoS for a UE from a source base station or a first CN node (e.g., events 528, 529). In some implementations, the data is associated with a PDU session or a QoS flow. At block 830, the target base station transmits, to the source base station or the first CN node, a Handover Request Acknowledge message including a handover command message for handing over the UE to the target base station (e.g., events 530, 531). At block 818, the target base station receives a handover complete message from the UE (e.g., event 518). At block 826A, the target base station communicates data for the UE with a second CN node using PDU set information (e.g., event 526). In some implementations, the data is associated with a PDU session or a QoS flow. At block 826B, the target base station communicates data with the UE in accordance with the PDU set QoS parameters (e.g., event 526). In some implementations, the data is associated with a PDU session or a QoS flow.

When processing DL data packets, the target base station executes block 826A and then block 826B. When processing UL data packets, the target station executes block 826B and then block 826A.

In some implementations, the handover command message and handover complete message are a RRC reconfiguration and a RRC reconfiguration complete message, respectively.

FIG. 8B is a flow diagram of an example method 800B similar to the method 800A, with the differences discussed below. At block 828B, the target base station receives a Handover Request message for a UE from a source base station or a first CN node (e.g., events 528, 529). At block 807, the target base station determines whether the Handover Request message includes PDU set QoS parameters (e.g., for a PDU session or a QoS flow). If the target base station determines that the Handover Request message includes PDU set QoS parameters (e.g., for a PDU session or a QoS flow) at block 807, the flow proceeds to block 826A. Otherwise, if the target base station determines that the Handover Request message does not include PDU set QoS parameters (e.g., for the PDU session or the QoS flow) at block 807, the flow proceeds to block 866, where the target base station communicates data (e.g., associated with the PDU session or the QoS flow) for the UE with a core network without using PDU set information (e.g., event 326). At block 867, the target base station communicates data (e.g., associated with the PDU session or the QoS flow) with the UE, based on non-PDU set QoS parameters (e.g., event 326).

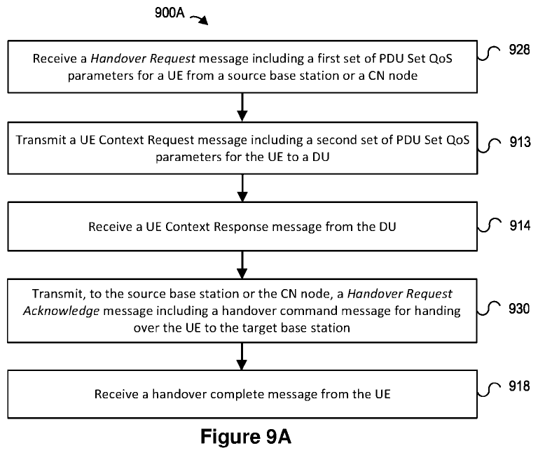

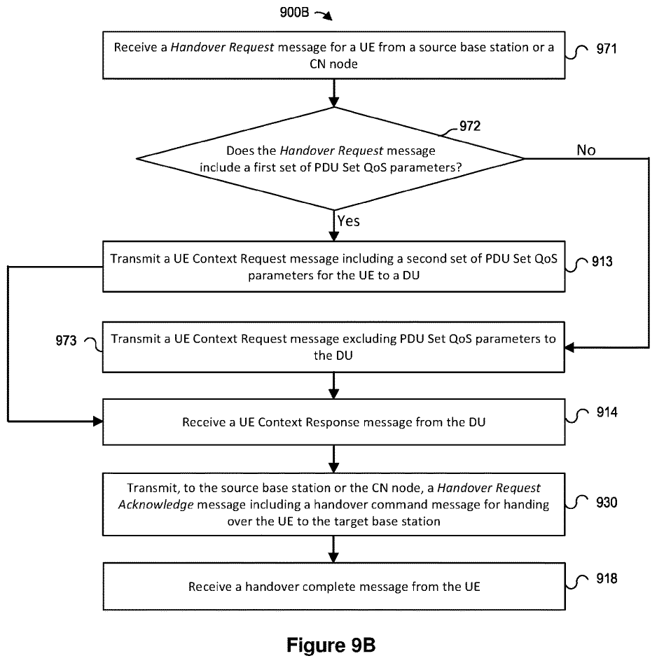

FIG. 9A is a flow diagram of an example method 900A for performing PDU set based QoS handling on data for a UE (e.g., the UE 102), which can be implemented by a CU of a target base station (e.g., the base station 104 or 106).

The method 900A begins at block 928, where the CU receives a Handover Request message including a first set of PDU set QoS parameters (e.g., for a PDU session or a QoS flow) for a UE from a source base station or a CN node (e.g., events 528, 529). At block 913, the target base station transmits a UE Context Request message including a second set of PDU set QoS parameters (e.g., for the PDU session or the QoS flow) for the UE to a DU (e.g., events 313, 513). At block 914, the CU receives a UE Context Response message from the DU (e.g., events 314, 514). At block 930, the CU transmits, to the source base station or the CN node, a Handover Request Acknowledge message including a handover command message for handing over the UE to the target base station (e.g., events 530, 531). At block 918, the CU receives a handover complete message from the UE (e.g., event 518).

In some implementations, the handover command message and handover complete message are a RRC reconfiguration and a RRC reconfiguration complete message, respectively.

FIG. 9B is a flow diagram of an example method 900B similar to the method 900A, except that method 900B includes blocks 971, 972, and 973 instead of block 928. At block 971, the CU receives a Handover Request message for a UE from a source base station or a CN node (e.g., events 528, 529). At block 972, the CU determines whether the Handover Request message includes a first set of PDU set QoS parameters (e.g., for a PDU session or a QoS flow) for the UE. If the CU determines that the Handover Request message includes a first set of PDU set QoS parameters (e.g., for the PDU session or the QoS flow) for the UE at block 972, the flow proceeds to block 913. Otherwise, if the CU determines that the Handover Request message does not include a first set of PDU set QoS parameters for (e.g., the PDU session or the QoS flow) for the UE at block 972, the flow proceeds to block 973, where the CU transmits a UE Context Request message excluding PDU set QoS parameters (e.g., for the PDU session or the QoS flow) to the DU (e.g., events 313, 513). The flow proceeds from block 973 to block 914.

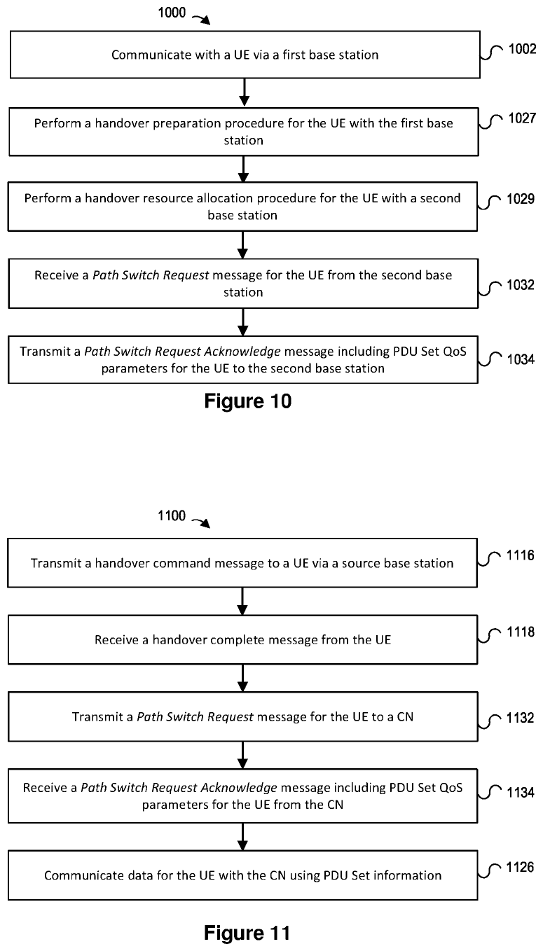

FIG. 10 is a flow diagram of an example method 700A for performing PDU set based QoS handling on data for a UE (e.g., the UE 102), which can be implemented by a CN (e.g., the CN 110).

The method 1000 begins at block 1002, where the CN communicates with a UE via a first base station (e.g., events 302, 304, 390, 490, 590). At block 027, the CN performs a handover preparation procedure for the UE with the first base station (e.g., events 527, 533). At block 1029, the CN performs a handover resource allocation procedure for the UE with a second base station (e.g., events 529, 531). At block 1032, the CN receives a Path Switch Request message for the UE from the second base station (e.g., event 532). At block 1010, the CN transmits a Patch Switch Request Acknowledge message including PDU set QoS parameters for the UE to the second base station (e.g., event 1034). In some implementations, the PDU set QoS parameters are associated with a PDU session or a QoS flow.

FIG. 11 is a flow diagram of an example method 1100 for performing PDU set based QoS handling on data for a UE, which can be implemented by a target base station (e.g., the base station 104).

The method 1100 begins at block 1116, where the target base station transmits a handover command message to a UE via a source base station (e.g., event 516). At block 1118, the target base station receives a handover complete message from the UE (e.g., event 518). At block 1132, the target base station transmits a Path Switch Request message for the UE to a CN (e.g., event 532). At block 1134, the target base station receives a Path Switch Request Acknowledge message including PDU set QoS parameters for the UE to from the CN (e.g., event 534). In some implementations, the PDU set QoS parameters are associated with a PDU session or a QoS flow. At block 1126, the target base station communicates data for the UE with the CN using PDU set information (e.g., event 526). In some implementations, the data is associated with the PDU session or QoS flow.

In some implementations, the handover command message and handover complete message are a RRC reconfiguration and a RRC reconfiguration complete message, respectively.

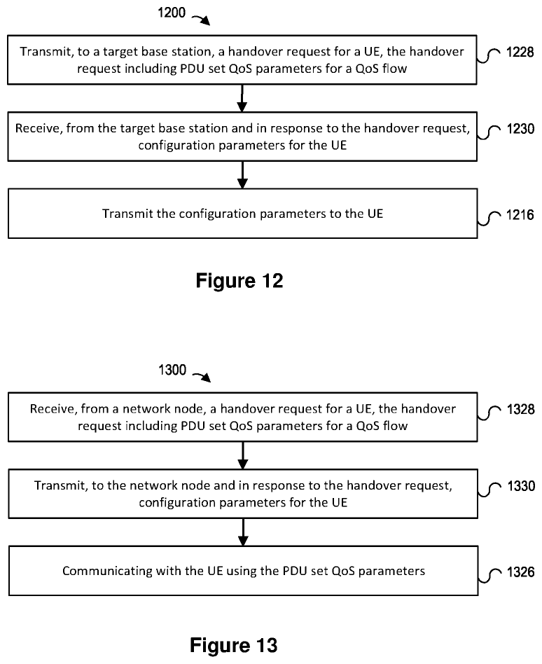

Next, FIG. 12 illustrates a flow diagram of an example method 1200 for configuring a UE for communication using PDU sets. The method 1200 can be implemented in a base station operating in the RAN 105 or in a node the CN 110 for example. At block 1228, the network node transmits, to a target base station, a handover request for a UE, the handover request including packet data unit (PDU) set quality of service (QoS) parameters for a QoS flow (see, e.g., event 528 in FIG. 5A, event 529 in FIG. 5B, block 628 in FIGS. 6A and 6B, block 729 in FIGS. 7A-C, block 1029 in FIG. 10). At block 1230, the network node receives, from the target base station and in response to the handover request, configuration parameters for the UE (see, e.g., event 530 in FIG. 5A, event 531 in FIG. 5B, block 630 in FIGS. 6A and 6B, block 731 in FIGS. 7A-C, block 1029 in FIG. 10). At block 1216, the network node transmits configuration parameters to the UE (see, e.g., event 516 in FIGS. 5A and 5B, event 616 in FIGS. 6A and 6B, block 733 in FIGS. 7A-C, block 1029 in FIG. 10).

FIG. 13 is a flow diagram of an example method 1300 for configuring a UE for communication using PDU sets, which can be implemented in a RAN node operating in the RAN 105 for example (e.g., a base station, a CU of a distributed base station, a CU-CP of a distributed base station, a CU-UP of a distributed base station, a DU of a distributed base station). At block 1328, the RAN node receives, from a network node, a handover request for a UE, the handover request including packet data unit (PDU) set quality of service (QoS) parameters for a QoS flow (see, e.g., event 528 in FIG. 5A, event 529 in FIG. 5B, block 828A in FIG. 8A, block 828B in FIG. 8B, block 928 in FIG. 9A, block 971 in FIG. 9B). At block 1330, the RAN node transmits, to the network node and in response to the handover request, configuration parameters for the UE (see, e.g., event 530 in FIG. 5A, event 531 in FIG. 5B, block 830 in FIGS. 8A and 8B, block 930 in FIGS. 9A and 9B). At block 1326, the RAN node communicates with the UE using the PDU set QoS parameters (see, e.g., events 522, 524, and 526 in FIGS. 5A and 5B, block 826B in FIGS. 8A and 8B).

The following list of examples reflects a variety of the embodiments explicitly contemplated by the present disclosure.

Example 1. A method implemented in a network node, the method comprising: transmitting, to a target base station, a handover request for a UE, the handover request including packet data unit (PDU) Set quality of service (QoS) parameters for a QoS flow; receiving, from the target base station and in response to the handover request, configuration parameters for the UE; and transmitting, to the UE, the configuration parameters.

Example 2. The method of example 1, wherein the handover request includes an identifier of a PDU session that includes the QoS flow.

Example 3. The method of example 1, wherein the handover request includes an identifier of the QoS flow.

Example 4. The method of example 1 or 2, wherein the handover request includes non-PDU Set QoS parameters.

Example 5. The method of any of the preceding examples, wherein the PDU Set QoS parameters include at least one of: (i) a PDU Set Delay Budget (PSDB), (ii) a PDU Set Error Rate (PSER), (iii) a PDU Set Integrated Handling Information (PSIHI).

Example 6. The method of any of the preceding examples, wherein the PDU Set QoS parameters include an uplink (UL) PDU Set QoS parameter.

Example 7. The method of any of the preceding examples, wherein: the PDU Set QoS parameter include a downlink (DL) PDU Set QoS parameter.

Example 8. The method of any of the preceding examples, the method further comprising: communicating, with the UE and prior to the transmitting of the handover request, PDUs according to first PDU Set QoS parameters; wherein the PDU Set QoS parameters are second PDU Set QoS parameters generated based on the first PDU Set QoS parameters.

Example 9. The method of any of the preceding examples, wherein the configuration parameters for the UE are included in a Radio Resource Control (RRC) message.

Example 10. The method of any of the preceding examples, further comprising: receiving the configuration parameters from the target base station in response to the handover request.

Example 11. The method of example 10, wherein the configuration parameters are included in a handover request acknowledgement message.

Example 12. The method of any of the preceding examples, wherein the network node is a source base station operating in a radio access network (RAN) of the target base station.

Example 13. The method of example 12, further comprising: including the PDU Set QoS parameters in the handover request message in response to determining that the source base station received the PDU Set QoS parameters for the PDU.

Example 14. The method of any of examples 1-11, wherein the network node is implemented in a core network (CN) in communication with a radio access network (RAN) of the target base station.

Example 15. The method of example 14, further comprising: receiving, prior to the transmitting of the handover request, a handover required message from a source base station.

Example 16. The method of example 15, further comprising: including the PDU Set QoS parameters in the handover request message in response to determining that handover required message includes the PDU Set QoS parameters.

Example 17. The method of example 14 or 15, further comprising: including the PDU Set QoS parameters in the handover request message in response to determining that the CN configured the PDU set QoS parameters for the UE.

Example 18. A method implemented in a radio access network (RAN) node, the method comprising: receiving, from a network node, a handover request for a UE, the handover request including packet data unit (PDU) Set quality of service (QoS) parameters for a QoS flow; transmitting, to the network node and in response to the handover request, configuration parameters for the UE; and communicating with the UE using the PDU Set QoS parameters.

Example 19. The method of example 18 implemented in a central unit (CU) of a target base station, the method further comprising: in response to the receiving of the handover request, transmitting the PDU Set QoS parameters to a distributed unit (DU) of the target base station.

Example 20. The method of example 19, wherein the PDU Set QoS parameters are transmitted to the DU in a UE Context Request message.

Example 21. The method of example 18, wherein the handover request includes an identifier of a PDU session that includes the QoS flow.

Example 22. The method of any of claims 18-21, wherein the handover request includes an identifier of the QoS flow.

Example 23. The method of any of claims 18-22, wherein the handover request includes non-PDU Set QoS parameters.

Example 24. The method of any of examples 18-23, wherein the PDU Set QoS parameters include at least one of: (i) a PDU Set Delay Budget (PSDB), (ii) a PDU Set Error Rate (PSER), (iii) a PDU Set Integrated Handling Information (PSIHI).

Example 25. The method of any of examples 18-24, wherein the PDU Set QoS parameters include an uplink (UL) PDU Set QoS parameter.

Example 26. The method of any of examples 18-25, wherein the PDU Set QoS parameter include a downlink (DL) PDU Set QoS parameter.

Example 27. The method of any of examples 18-26, further comprising: transmitting, to the network node and in response to the handover request, configuration parameters for the UE.

Example 28. The method of example 27, wherein the configuration parameters are included in a handover request acknowledgement message.

Example 29. The method of any of examples 18-28, further comprising: performing, subsequently to the receiving of the handover request, a bearer context modification procedure using the PUD Set QoS parameters Example 30. The method of any of the preceding examples, wherein the PDU Set QoS parameter pertains to a PDU set that includes a plurality of PDUs carrying a payload of a unit of information generated an application level.

Example 31. An apparatus comprising processing hardware and configured to implement a method of any of the preceding examples.

Example 32. A method in a target radio access network (RAN) node for managing protocol data unit (PDU) set-based communications, the method comprising: receiving, at the target RAN node, quality of service (QoS) parameters which a source RAN node uses for the PDU set-based communications with a user equipment (UE); and using the QoS parameters for the PDU set-based communications with the UE, when the UE performs a handover from the source RAN node to the target RAN node.

Example 33. The method of example of example 31, wherein the receiving of the QoS parameters includes receiving a request for a context for the UE.

Example 34. The method of example 33, wherein the source node is a first distributed unit (DU) in a distributed base station; the target node is a second DU in the distributed base station.

Example 35. The method of example 34, wherein the target node is a DU in a distributed base station; and the source node is implemented in another base station.

Example 36. The method of example of example 32, wherein: the receiving of the QoS parameters includes receiving a handover request.

Example 37. The method of example 36, wherein the handover request is received from the source node implemented in another base station.

Example 38. The method of example of example 36, wherein the handover request is received from a core network.

Example 39. The method of example of example 32, wherein the receiving of the QoS parameters includes: transmitting, to a CN, a request to switch a connection path from the source RAN node to the target RAN node; and receiving, from the CN and in response to the request, an acknowledgement message including the QoS parameters.

Example 40. The method of any of examples 32-39, further comprising: receiving an identifier of a QoS flow with which the QoS parameters are associated.

Example 41. The method of any of examples 32-40, further comprising: receiving an identifier of a PDU session with which the QoS parameters are associated.

Example 42. The method of any of claims 32-41, further comprising: configuring resources for the UE based on the QoS parameters for the PDU set-based communications.

Example 43. A method in a source radio access network (RAN) node for managing protocol data unit (PDU) set-based communications, the method comprising: communicating, with a UE, using quality of service (QoS) parameters for the PDU set-based communications; transmitting, to a target RAN node or a core network (CN), a message related to a handover of the UE from the source RAN node to the target RAN node, the message including the QoS parameters for the PDU set-based communications.

Example 44. The method of example 43, wherein: the message is a handover request message transmitted to the target RAN node.

Example 45. The method of example 43, wherein: the message is a handover required message transmitted to the CN.

Example 46. A radio access network (RAN) node comprising: a transceiver; and processing hardware configured to implement a method according to any of the preceding examples.

Example 47. A method in a core network (CN) for managing protocol data unit (PDU) set-based communications, the method comprising: communicating data packets with a UE via a source radio access network (RAN) node, using first quality of service (QoS) parameters for the PDU set-based communications; receiving an indication that the UE performs a handover from the source RAN node to a target RAN node; and providing, to the target RAN node, second QoS parameters for the PDU set-based communications.

Example 48. The method of example 47, further comprising: setting the second QoS parameters to be identical to the first QoS parameters.

Example 49. The method of example 47, further comprising: generating the second QoS parameters based on the first QoS parameters in view of memory and/or processing power capability of the target RAN node.

Example 50. The method of any of examples 47-49, wherein: the receiving of the indication that the UE performs the handover includes receiving a handover required message; and the providing of the second QoS parameters is in response to determining that the handover required message includes the first quality of service (QoS) parameters.

Example 51. The method of any of examples 47-49, wherein: the receiving of the indication that the UE performs the handover includes receiving a handover required message that does not include the first QoS parameters.

Example 52. The method of any of examples 48-51, wherein: the providing of the second QoS parameters includes transmitting a handover request message to the target RAN node.

Example 53. The method of any of examples 48-51, wherein: the providing of the second QoS parameters includes transmitting a handover request message to the target RAN node.

Example 54. The method of any of examples 48-51, wherein the transmitting of the second QoS parameters includes: receiving, from the target RAN node, a request to switch a connection path from the source RAN node to the target RAN node; and transmitting, to the target RAN node and in response to the request, an acknowledgement message including the second QoS parameters.

Example 55. A core network (CN) node comprising processing hardware and configured to implement a method of any of examples 47-54.

The following additional considerations apply to the foregoing discussion.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “at least one” means “one or more”. In some implementations, “PDU set based QoS handling” can be replaced by “PDU set handling”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

When implemented in software, the techniques can be provided as part of the operating system, a library used by multiple applications, a particular software application, etc. The software can be executed by one or more general-purpose processors or one or more special-purpose processors.

1. A method implemented in a network node, the method comprising:
transmitting, to a target base station, a handover request for a UE, the handover request including packet data unit (PDU) set quality of service (QoS) parameters for a QoS flow;
receiving, from the target base station and in response to the handover request, configuration parameters for the UE; and
transmitting, to the UE, the configuration parameters.

2. The method of claim 1, wherein:
the handover request includes an identifier of a PDU session that includes the QoS flow.

3. The method of claim 1, wherein:
the handover request includes non-PDU set QoS parameters.

4. The method of claim 1, wherein:
the configuration parameters for the UE are included in a Radio Resource Control (RRC) message.

5. The method of claim 1, wherein:
the network node is implemented a source base station operating in a radio access network (RAN) of the target base station.

6. The method of claim 1, wherein:
the network node is implemented in a core network (CN) in communication with a radio access network (RAN) of the target base station.

7. The method of claim 6, further comprising:
receiving, prior to the transmitting of the handover request, a handover required message from a source base station.

8. The method of claim 7, further comprising:
including the PDU set QoS parameters in the handover request message in response to determining that handover required message includes the PDU set QoS parameters.

9. The method of claim 6, further comprising:
including the PDU set QoS parameters in the handover request message in response to determining that the CN configured the PDU set QoS parameters for the UE.

10. A method implemented in a radio access network (RAN) node, the method comprising:
receiving, from a network node, a handover request for a UE, the handover request including packet data unit (PDU) set quality of service (QoS) parameters for a QoS flow;
transmitting, to the network node and in response to the handover request, configuration parameters for the UE; and
communicating with the UE using the PDU set QoS parameters.

11. The method of claim 10 implemented in a central unit (CU) of a target base station, the method further comprising:
in response to the receiving of the handover request, transmitting the PDU set QoS parameters to a distributed unit (DU) of the target base station.

12. The method of claim 10, wherein:
the handover request includes non-PDU set QoS parameters.

13. (canceled)

14. The method of claim 10, further comprising:
performing, subsequently to the receiving of the handover request, a bearer context modification procedure using the PDU set QoS parameters.

15. The method of claim 10, wherein:
the PDU set QoS parameter pertains to a PDU set that includes a plurality of PDUs carrying a payload of a unit of information generated an application level.

16. An apparatus comprising processing hardware and configured to:
transmit, to a target base station, a handover request for a UE, the handover request including packet data unit (PDU) set quality of service (QoS) parameters for a QoS flow;
receive, from the target base station and in response to the handover request, configuration parameters for the UE; and
transmit, to the UE, the configuration parameters.

17. The method of claim 4, wherein the RRC message is an RRC reconfiguration command received in a handover request acknowledgement message.

18. The method of claim 10, wherein the transmitting of the configuration parameters includes transmitting an RRC reconfiguration message for the UE.

19. The method of claim 18, wherein the RRC reconfiguration message is included in a handover request acknowledgement message.

20. The apparatus of claim 16, wherein:
the handover request includes an identifier of a PDU session that includes the QoS flow.

21. The apparatus of claim 16, wherein:
the configuration parameters for the UE are included in an RRC reconfiguration message, RRC reconfiguration message included in a handover request acknowledgement message.
